(19) United States
(12) Patent Application Publication
(10) Pub. No.: US 2025/0381789 A1
(43) Pub. Date: Dec. 18, 2025

(54) LIQUID EJECTION APPARATUS

(71) Applicant: SEIKO EPSON CORPORATION, TOKYO (JP)

(72) Inventor: Shota SAKAGAMI, AZUMINO-SHI (JP)

(73) Assignee: SEIKO EPSON CORPORATION, TOKYO (JP)

(21) Appl. No.: 19/235,626

(22) Filed: Jun. 12, 2025

(30) Foreign Application Priority Data
Jun. 12, 2024 (JP) 2024-094940

(51) Int. Cl. B41J 29/377; B41J 2/045; B41J 2/17

(52) U.S. Cl. CPC B41J 29/377; B41J 2/04553; B41J 2/1714; B41J 2/04586

(57) ABSTRACT

A liquid ejection apparatus includes a liquid ejection unit, a support unit, and a drive board. The liquid ejection apparatus includes a first air suction passage, a first fan, a second air suction passage, a second fan, a bypass passage, and a switching mechanism. The first air suction passage suctions air at at least one of upstream and downstream positions of the liquid ejection unit with suction force of the first fan. The second air suction passage feeds external air to the drive board with suction force of the second fan. The bypass passage feeds air discharged from the first fan to the second air suction passage. The switching mechanism is configured to be switchable between an open state in which the bypass passage communicates with the second air suction passage and a closed state in which the bypass passage does not communicate with the second air suction passage.

The present application is based on, and claims priority from JP Application Serial Number 2024-094940, filed Jun. 12, 2024, the disclosure of which is hereby incorporated by reference herein in its entirety.

### BACKGROUND

### 1. Technical Field

The present disclosure relates to a liquid ejection apparatus including a liquid ejection unit that ejects a liquid.

### 2. Related Art

For example, as disclosed in JP-A-2021-126835, there is an inkjet printing apparatus which is an example of a liquid ejection apparatus that performs printing by ejecting ink which is an example of a liquid from an inkjet head which is an example of a liquid ejection unit. The inkjet head performs printing by ejecting ink from nozzles onto a print medium being transported.

The technology of JP-A-2021-126835 relates to a print unit that performs printing by ejecting the ink using the inkjet head. In this print unit, the inkjet head is efficiently cooled using a cooling fan while avoiding occurrence of a problem caused by a satellite which occurs due to ejection of the ink. Excessive heat generation of a drive board inside the inkjet head causes a failure or the like. Therefore, the drive board located inside is cooled by feeding air on the surface of the inkjet head.

In some liquid ejection apparatuses, a drive circuit for the inkjet head is disposed separately from the inkjet head. In addition, in the liquid ejection apparatus, not only the drive board but also various electronic circuit mounting boards are cooled using air generated by a cooling source such as a cooling fan.

JP-A-2021-126835 is an example of the related art.

However, when an abnormality occurs in the cooling source such as a cooling fan, there is no measure to cool the electronic circuit mounting board such as a drive board until the abnormality is removed. Therefore, it becomes unable to perform printing during this time, and downtime occurs. In addition, when a cooling source having a capacity which is sufficient but somewhat lower is used for the purpose of preventing a growth in size of the cooling source such as a cooling fan, there is a possibility that the electronic circuit mounting board cannot be sufficiently cooled due to insufficient capacity depending on a use situation or a use environment. As described above, when the flow rate of the cooling air is insufficient due to the abnormality of the cooling source for cooling the substrate or the limit of the capability, there is a problem that the electronic circuit mounting board cannot be appropriately cooled.

### SUMMARY

A liquid ejection apparatus configured to solve the problem described above includes: a liquid ejection unit configured to eject a liquid onto a medium; a support unit configured to support the medium at a position opposed to the liquid ejection unit; an electronic circuit mounting board; a first air suction passage configured to suction air at at least one of an upstream position and a downstream position of the liquid ejection unit in a relative movement direction between the medium supported by the support unit and the liquid ejection unit to cause the air to flow downstream in a suction direction; a first suction source configured to generate suction force capable of suctioning the air into the first air suction passage; a second air suction passage configured to feed external air to the electronic circuit mounting board; a second suction source configured to generate, in the second air suction passage, a flow of air in a feeding direction toward the electronic circuit mounting board; a bypass passage configured to feed, to the second air suction passage, the air discharged from the first suction source; and a switching mechanism configured to switch between an open state in which the bypass passage communicates with the second air suction passage and a closed state in which the bypass passage does not communicate with the second air suction passage.

### BRIEF DESCRIPTION OF THE DRAWINGS

FIG. 1 is a perspective view showing a liquid ejection apparatus according to a first embodiment.

FIG. 2 is a schematic front cross-sectional view showing the liquid ejection apparatus.

FIG. 3 is a schematic side cross-sectional view of the liquid ejection apparatus.

FIG. 4 is a schematic front cross-sectional view showing a device for cooling a drive board.

FIG. 5 is a schematic cross-sectional view showing a switching mechanism of a rotary type.

FIG. 6 is a schematic cross-sectional view showing a switching mechanism of a slide type.

FIG. 7 is a block diagram showing an electrical configuration of the liquid ejection apparatus.

FIG. 8 is a schematic front cross-sectional view showing an operation of cooling the drive board.

FIG. 9 is a schematic front cross-sectional view showing an operation of cooling the drive board.

FIG. 10 is a schematic front cross-sectional view showing an operation of cooling the drive board.

FIG. 11 is a schematic front cross-sectional view showing a device for cooling a drive board in a second embodiment.

FIG. 12 is a schematic front cross-sectional view showing an operation of cooling the drive board.

FIG. 13 is a schematic front cross-sectional view showing an operation of cooling the drive board.

FIG. 14 is a schematic front cross-sectional view showing an operation of cooling the drive board.

FIG. 15 is a schematic front cross-sectional view showing a device for cooling a drive board in a third embodiment.

FIG. 16 is a schematic front cross-sectional view showing an operation of cooling the drive board.

FIG. 17 is a schematic front cross-sectional view showing an operation of cooling the drive board.

FIG. 18 is a schematic front cross-sectional view showing an operation of cooling the drive board.

FIG. 19 is a schematic front cross-sectional view showing an operation of cooling the drive board.

FIG. 20 is a schematic cross-sectional view showing a switching mechanism of a rotary type in a modified example.

FIG. 21 is a schematic cross-sectional view showing a switching mechanism of a slide type in a modified example.

FIG. 22 is a schematic cross-sectional view showing a switching mechanism of a slide type in a modified example.

FIG. 23 is a schematic cross-sectional view showing a switching mechanism of a rotary type in a modified example.

### DESCRIPTION OF EMBODIMENTS

### First Embodiment

A first embodiment of a liquid ejection apparatus will hereinafter be described with reference to the drawings.

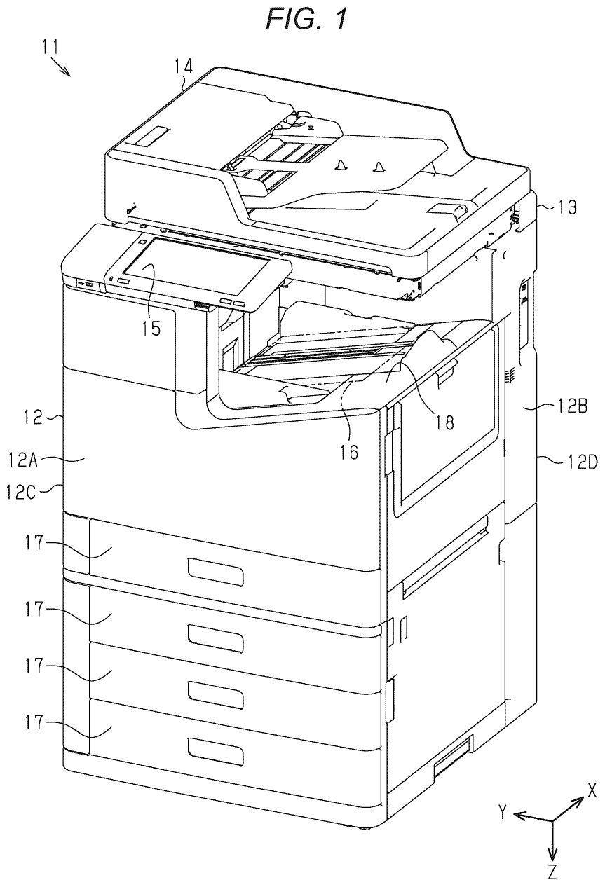

A liquid ejection apparatus 11 illustrated in FIG. 1 is an inkjet printer that ejects ink, which is an example of a liquid, onto a medium such as paper to perform recording.

In the drawings, a direction of gravity is represented by a z axis, and directions along a horizontal plane are represented by an X axis and a Y axis assuming that the liquid ejection apparatus 11 is placed on the horizontal plane. The X axis, the Y axis, and the Z axis are perpendicular to each other. In the following description, since the depth direction X parallel to the X axis is also the width direction of the medium to be printed, the depth direction X is also referred to as the width direction X. A direction parallel to the Z axis is also referred to as a vertical direction Z.

As illustrated in FIG. 1, the liquid ejection apparatus 11 may include an apparatus main body 12, an image reading apparatus 13 disposed on the apparatus main body 12, and an automatic feeding apparatus 14. The apparatus main body 12 exhibits a substantially rectangular parallelepiped shape and includes four side plates 12A to 12D. The four side plates 12A to 12D face to the front, right, left, and back surfaces, respectively. The image reading apparatus 13 may read the image of the medium 16 recorded by the apparatus main body 12. The automatic feeding apparatus 14 feeds the medium 16 to the image reading apparatus 13.

The liquid ejection apparatus 11 may include an operation unit 15 for performing various operations of the liquid ejection apparatus 11, a medium housing unit 17 capable of housing the medium 16 as a single sheet, and a stacker 18 that receives the medium 16 discharged. The operation unit 15 may be, for example, a touch panel, a button, or a touch pad, or may be a combination thereof. The medium housing unit 17 can house a plurality of media 16 in a stacked state. The liquid ejection apparatus 11 may include a plurality of medium housing units 17. The liquid ejection apparatus 11 of the present embodiment includes, for example, four medium housing units 17.

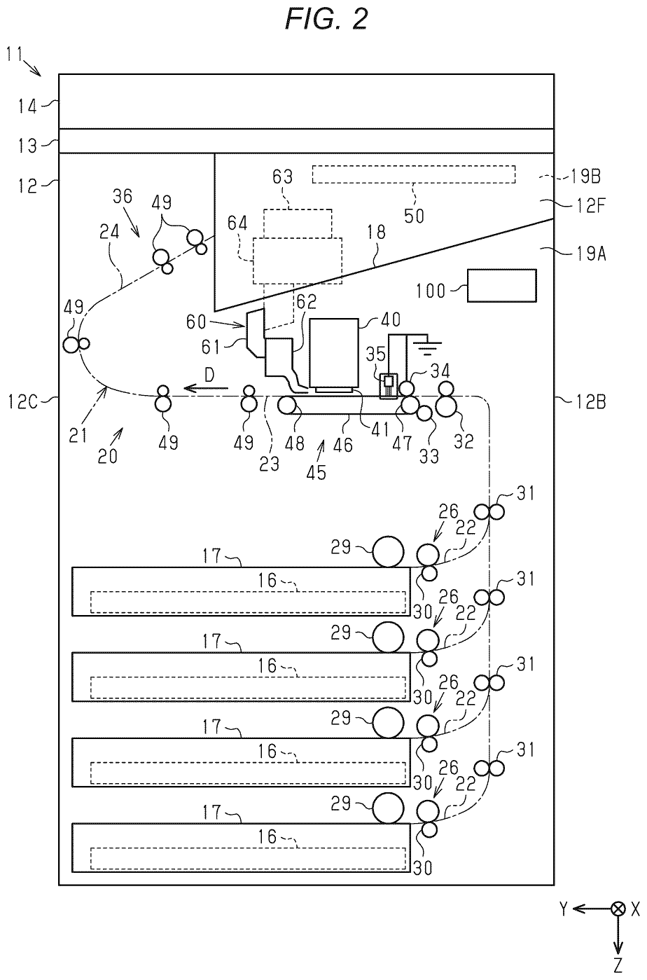

As illustrated in FIG. 2, the liquid ejection apparatus 11 includes a conveyance unit 20 that conveys the medium 16 along a conveyance path 21. The conveyance unit 20 conveys the medium 16 along a conveyance direction D. The conveyance direction D is a direction along the conveyance path 21.

The conveyance path 21 includes a path indicated by a dashed-dotted line connecting the medium housing unit 17 located upstream and the stacker 18 located downstream. The conveyance path 21 may include feeding paths 22 located the most upstream, a feed path 23 extending substantially horizontally, and a discharge path 24 located the most downstream. The conveyance path 21 has the same number of feeding paths 22 as the number of medium housing units 17. Each feeding path 22 joins the feed path 23. The liquid ejection apparatus 11 may include a flipping path (not illustrated) or a flipping mechanism (not illustrated) that flips the medium 16. The medium 16 may be recorded on both sides by being flipped.

The liquid ejection apparatus 11 may include feeding units 26 each feeding the medium 16 from the medium housing unit 17. The same number of feeding units 26 as the number of medium housing units 17 may be provided. The liquid ejection apparatus 11 may include, for example, four feeding units 26. Each feeding unit 26 feeds the medium 16 housed in the corresponding medium housing unit 17 to the corresponding feeding path 22.

The feeding unit 26 may include a feeding roller 29 that feeds the medium 16 housed in the medium housing unit 17 and a separation unit 30 that separates the medium 16 one by one. In addition, the feeding unit 26 may include a roller pair 31 that transports the medium 16 thus separated along the feeding path 22.

The liquid ejection apparatus 11 may include a registration roller 32 for correcting skew of the medium 16. The registration roller 32 may be formed of a pair of rollers. The registration roller 32 conveys the medium 16 downstream in the conveyance direction D after correcting the skew of the medium 16.

The liquid ejection apparatus 11 includes a liquid ejection unit 40 that ejects a liquid onto the medium 16, and a support unit 45 that supports the medium 16 at a position opposed to the liquid ejection unit 40.

The liquid ejection unit 40 performs printing on the medium 16 by ejecting the liquid onto the medium 16 conveyed along the feed path 23. The liquid ejection unit 40 may be of a line type capable of ejecting the liquid in the entire length in the width direction X of the medium 16. The liquid ejection unit 40 may have a predetermined length slightly longer than the maximum medium width in the width direction X. The liquid ejection apparatus 11 may be a line printer of this type. Note that the liquid ejection unit 40 may be of a serial type that performs printing by ejecting the liquid while moving in the width direction X of the medium 16. That is, the liquid ejection apparatus 11 may be a serial printer.

The liquid ejection unit 40 includes an ejection head 41 in a lower portion opposed to the support unit 45. The ejection head 41 has a nozzle opening surface opposed to the support unit 45. Nozzles open on the nozzle opening surface. A plurality of nozzles, for example, is disposed. The plurality of nozzles may be disposed at a nozzle pitch corresponding to the printing resolution in the width direction X. The liquid ejection unit 40 prints a character or an image on the medium 16 by ejecting the liquid from the nozzles.

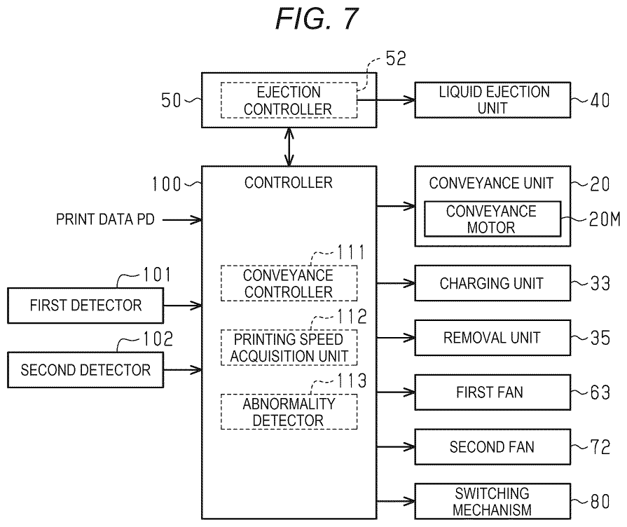

The support unit 45 may be a conveyance belt unit including a conveyance belt 46 that supports the medium 16. In this case, the support unit 45 may include a conveyance belt 46 of an endless type, and a driving pulley 47 and a driven pulley 48 around which the conveyance belt 46 is wound. The driving pulley 47 is rotated by driving force of a conveyance motor 20M (see FIG. 7) which is a drive source of the conveyance unit 20. The driven pulley 48 is provided to be rotatable about an axis parallel to the axis of the driving pulley 47. The conveyance belt 46 conveys the medium 16 by, for example, circulating in a state where the medium 16 is supported on the outer peripheral surface with electrostatic adsorption.

The liquid ejection apparatus 11 includes a charging unit 33 that charges the conveyance belt 46. The charging unit 33 is in contact with the conveyance belt 46. The charging unit 33 charges the conveyance belt 46 by coming into contact with the outer peripheral surface of the conveyance belt 46. The medium 16 is electrostatically attracted to the conveyance belt 46 thus charged. The charging unit 33 is, for example, a roller to which a voltage is applied. The charging unit 33 rotates as the conveyance belt 46 rotates.

The liquid ejection apparatus 11 may include a ground roller 34 that stabilizes the potential of the medium 16, and a removal unit 35 that removes paper dust, fine dust, and the like adhering to the medium 16. The removal unit 35 may be, for example, a destaticizing unit having a destaticizing brush. The destaticizing brush performs destaticizing for removing charges charged on the surface of the medium 16. In addition, the destaticizing brush removes foreign matter such as paper dust adhering to the surface of the medium 16 thus charged. The foreign matter removed by the removal unit 35 may be collected by a foreign matter collection device (not illustrated).

The conveyance unit 20 may include a discharge unit 36. The discharge unit 36 conveys the medium 16 thus recorded to the stacker 18 along the conveyance path 21. The discharge unit 36 includes a plurality of conveyance roller pairs 49 disposed along the conveyance path 21. The conveyance roller pairs 49 may include one that discharges the medium 16 along the discharge path 24. The conveyance roller pairs 49 convey the medium 16 by rotating while pinching the medium 16.

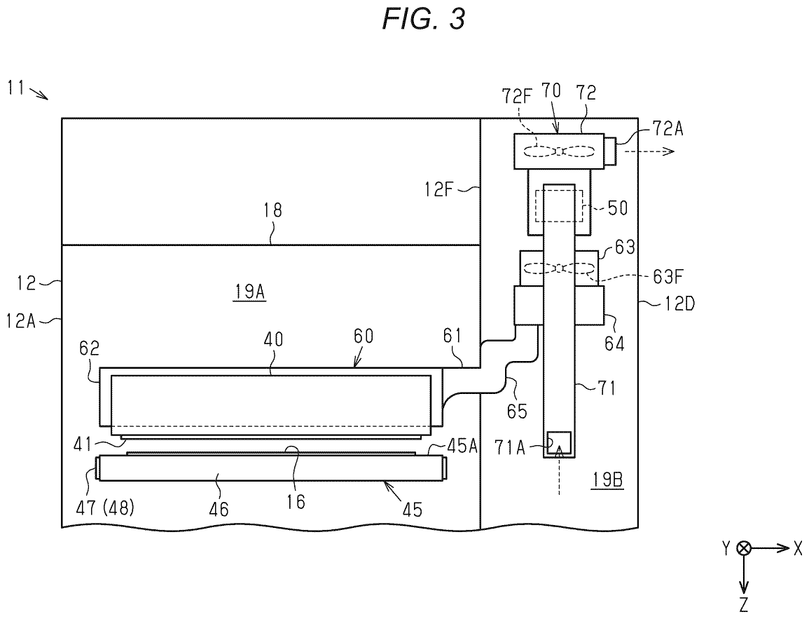

The liquid ejection apparatus 11 includes a mist collection device 60 and an air-cooling device 70 (see FIG. 3). The mist collection device 60 includes a first air suction passage 61, and a first fan 63 as an example of a first suction source.

The first air suction passage 61 suctions air at a position downstream of the liquid ejection unit 40 in the conveyance direction D, which is a relative movement direction between the medium 16 supported by the support unit 45 and the liquid ejection unit 40, and causes the air to flow downstream in the suction direction. The first air suction passage 61 may have a suction port at a position where the air located between the liquid ejection unit 40 and the support unit 45 can be suctioned.

The first fan 63 generates suction force capable of suctioning the air into the first air suction passage 61. The first fan 63 is a mist collecting fan that generates suction force for collecting the mist generated when the liquid ejection unit 40 ejects the liquid.

The first air suction passage 61 has a mist suction unit 62 in an upstream portion thereof. The mist suction unit 62 suctions the mist generated when the ejection head 41 discharges droplets from the nozzles. The air containing the suctioned mist flows in the suction direction along the first air suction passage 61. The mist collection device 60 includes a capturing unit 64 to which the downstream end portion of the first air suction passage 61 is coupled. The capturing unit 64 captures the mist and the like contained in the air. The first fan 63 exhausts the air after the mist is captured.

The liquid ejection apparatus 11 includes a drive board 50 which is an example of an electronic circuit mounting board. The drive board 50 outputs a drive signal to the liquid ejection unit 40. The liquid ejection unit 40 ejects the liquid from the nozzles based on the drive signal.

The drive board 50 generates heat when performing discharge control for causing the liquid ejection unit 40 to eject the liquid. Therefore, the liquid ejection apparatus 11 includes the air-cooling device 70 that cools the drive board 50. The drive board 50 is cooled by air cooling by the air-cooling device 70.

The liquid ejection apparatus 11 includes a controller 100 that controls the liquid ejection apparatus 11. The controller 100 controls the conveyance unit 20, the mist collection device 60, the air-cooling device 70 (see FIG. 3), and so on. The controller 100 is communicably coupled to the drive board 50. Print data PD (see FIG. 7) is input to the controller 100. The controller 100 transmits image data and so on in the print data PD to the drive board 50. The drive board 50 controls the liquid ejection unit 40 based on the image data and so on to eject the liquid such as ink from the nozzles of the ejection head 41.

The drive board 50 may include, for example, an application specific integrated circuit (ASIC). The drive board 50 may include a CPU that executes a program. The drive board 50 may include the ASIC and the CPU.

The controller 100 includes, for example, a processing circuit including a computer and a memory. The controller 100 controls the conveyance unit 20, the mist collection device 60, the air-cooling device 70, and so on in accordance with the program stored in the memory. The controller 100 is electrically coupled to the drive board 50 in a state where data and signals can be exchanged with the drive board 50. The controller 100 performs communication necessary for controlling the drive board 50 and the liquid ejection unit 40. The controller 100 transmits image data and so on contained in the print data PD input thereto to the drive board 50. The drive board 50 generates a drive signal based on the image data and so on.

### Configurations of Mist Collection Device 60 and Air-Cooling Device 70

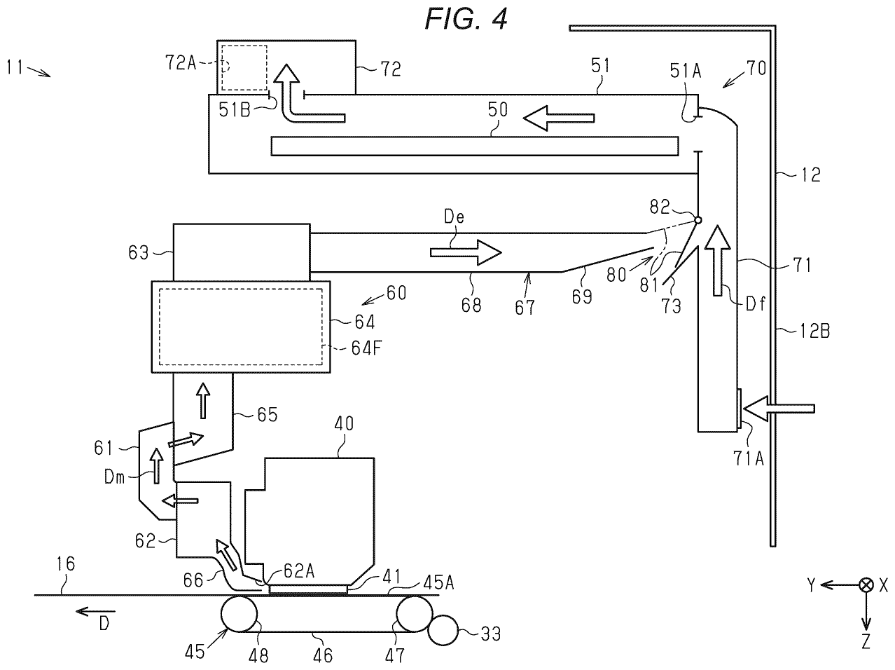

Then, configurations of the mist collection device 60 and the air-cooling device 70 will be described with reference to FIGS. 3 and 4.

As shown in FIG. 3, the inside of the apparatus main body 12 is partitioned into a first chamber 19A and a second chamber 19B. The first chamber 19A and the second chamber 19B are partitioned by a partition plate 12F disposed inside the apparatus main body 12. The partition plate 12F is used for assembling, for example, the conveyance unit 20 and the liquid ejection unit 40. The first chamber 19A and the second chamber 19B may have respective portions communicating with each other via a hole or an opening of the partition plate 12F.

As shown in FIGS. 3 and 4, the mist collection device 60 is disposed across the first chamber 19A and the second chamber 19B. The air-cooling device 70 is housed in the second chamber 19B.

The liquid ejection apparatus 11 includes a housing unit 51 in which the drive board 50 is housed. The drive board 50 is housed in the housing unit 51 disposed at a predetermined height in the second chamber 19B of the apparatus main body 12. The housing unit 51 may be, for example, a housing box. The housing unit 51 may constitute a part of the air-cooling device 70. That is, the air-cooling device 70 may include the housing unit 51.

The housing unit 51 is used as a cooling box through which the air for cooling the drive board 50 flows. The housing unit 51 has an intake port 51A of the air and an exhaust port 51B of the air on both sides in the longitudinal direction (e.g., the Y direction). The air flows inside the housing unit 51 in the +Y direction from the intake port 51A toward the exhaust port 51B. The drive board 50 housed in the housing unit 51 is cooled by the air flowing in the +Y direction. In this way, the air-cooling device 70 cools the drive board 50 by an air-cooling method.

The mist collection device 60 includes the first air suction passage 61 and the first fan 63 described above.

The first fan 63 generates suction force capable of suctioning the air into the first air suction passage 61. The first fan 63 includes a fan 63F which is rotatable (see FIG. 3, not shown in FIG. 4) inside thereof. The first fan 63 may be an axial fan or a centrifugal fan. By the fan 63F rotating, the first fan 63 exhausts the air, which is suctioned from the intake port, from the exhaust port. The suction force acting on the intake port of the first fan 63 reaches the first air suction passage 61.

As illustrated in FIG. 4, the first air suction passage 61 suctions air at a position downstream of the liquid ejection unit 40 in the conveyance direction D which is a relative movement direction between the medium 16 supported by the support unit 45 and the liquid ejection unit 40. The first air suction passage 61 allows the suctioned air to flow downstream in the suction direction Dm (see FIG. 4). In the present embodiment, the first air suction passage 61 suctions the air located between the support unit 45 and the liquid ejection unit 40 and causes the air to flow downstream in the suction direction Dm.

The first air suction passage 61 includes the mist suction unit 62 and a first suction duct 65. The mist suction unit 62 is disposed at a position downstream of the ejection head 41 in the conveyance direction D. As shown in FIG. 3, the mist suction unit 62 extends along the longitudinal direction of the ejection head 41. The mist suction unit 62 has a suction nozzle portion 66 (see FIG. 4) extending obliquely downward toward the ejection head 41. The suction nozzle portion 66 has a first suction port 62A that opens at the lower end portion. The first suction port 62A is disposed at a height position at which the air located between the liquid ejection unit 40 and the support unit 45 can be suctioned in the vertical direction Z. The first suction port 62A is located, for example, above a support surface 45A which is an upper surface of the support unit 45, and below an upper surface of the liquid ejection unit 40 in the vertical direction Z. In the example illustrated in FIGS. 3 and 4, the first suction port 62A is located above the nozzle surface which is the lower surface of the ejection head 41. For example, the first suction port 62A may be located above the ejection head 41. In short, the height position of the first suction port 62A in the vertical direction Z may be appropriately changed as long as the air located between the ejection head 41 and the support unit 45 can be suctioned.

The first suction duct 65 extends from the first chamber 19A to the second chamber 19B across the partition plate 12F. A downstream end portion of the first suction duct 65 is coupled to an intake port of the capturing unit 64 disposed in the second chamber 19B. An exhaust port side of the capturing unit 64 is coupled to the first fan 63.

The capturing unit 64 captures the mist contained in the suctioned air. The capturing unit 64 includes a filter 64F inside. The first fan 63 suctions the air, from which the mist was removed by the filter 64F, from the intake port and discharges the air from the exhaust port.

Further, as shown in FIGS. 3 and 4, the air-cooling device 70 includes a second air suction passage 71 and a second fan 72 as an example of a second suction source. Since the second fan 72 is a cooling fan that generates a suction airflow, the second fan 72 is an example of a suction source, and is also an example of a cooling source for cooling the electronic circuit mounting board.

The second air suction passage 71 feeds external air to the drive board 50. The second air suction passage 71 extends along a predetermined direction. In the example shown in FIG. 4, the second air suction passage 71 extends along, for example, the vertical direction Z. The second air suction passage 71 has a second suction port 71A for suctioning air outside the apparatus main body 12 at one end portion in the longitudinal direction thereof. In a side plate 12B on the right side surface of the apparatus main body 12, a vent hole (not illustrated) is opened at a position opposed to the second suction port 71A. The vent hole may be formed of a plurality of holes. The second air suction passage 71 suctions air located outside the side plate 12B from the second suction port 71A via the vent hole. The air suctioned from the second suction port 71A flows in the second air suction passage 71 in the feeding direction Df. A downstream end portion in the feeding direction Df of the second air suction passage 71 is coupled to the intake port 51A of the housing unit 51.

Further, the second fan 72 generates a flow of air in the second air suction passage 71 in the feeding direction Df toward the drive board 50. The second fan 72 includes a fan 72F (see FIG. 3, not shown in FIG. 4) which can rotate inside the second fan 72. The second fan 72 may be an axial fan or a centrifugal fan.

The second fan 72 is disposed at one end portion at the exhaust port 51B side in the longitudinal direction (air flow direction) of the housing unit 51. In the example illustrated in FIG. 4, the second fan 72 is disposed in a state in which the exhaust port 51B opened in the upper surface of the housing unit 51 and an intake port (not illustrated) thereof communicate with each other. The intake port of the second fan 72 communicates with the exhaust port 51B. The second fan 72 suctions air from the exhaust port 51B located near one end portion of the housing unit 51. The second fan 72 has an exhaust port 72A for exhausting the suctioned air. When the second fan 72 suctions the air inside the housing unit 51 from the exhaust port 51B, the air suctioned from the second suction port 71A into the second air suction passage 71 further flows inside the housing unit 51 in a direction (+Y direction) from the intake port 51A toward the exhaust port 51B. The drive board 50 is cooled by the air flowing inside the housing unit 51. The air used for cooling the drive board 50 is exhausted from the exhaust port 72A of the second fan 72. The air discharged from the exhaust port 72A is further discharged to the outside of the apparatus main body 12 from the vent hole opened in the side plate 12D at the back side.

As illustrated in FIG. 4, the liquid ejection apparatus 11 includes a bypass passage 67 coupled to an exhaust port (not illustrated) of the first fan 63. The bypass passage 67 selectively couples the exhaust port of the first fan 63 and the second air suction passage 71 to each other. The bypass passage 67 is configured to be able to feed the air discharged from the first fan 63 to the second air suction passage 71. The bypass passage 67 of the present embodiment includes a first bypass passage 68 and a second bypass passage 73.

The first bypass passage 68 extends from the exhaust port of the first fan 63 toward a direction (e.g., the −Y direction) in which the second air suction passage 71 is located. An upstream end portion in the discharge direction De of the first bypass passage 68 is coupled to an exhaust port (not shown) of the first fan 63. The first bypass passage 68 extends substantially horizontally to a position near the second air suction passage 71. The air exhausted by the first fan 63 flows in the exhaust direction De through the first bypass passage 68. The downstream end in the discharge direction De of the first bypass passage 68 is located closer to the second air suction passage 71 than the first fan 63.

The second bypass passage 73 is a passage branched from an intermediate position of the second air suction passage 71. The second bypass passage 73 extends from an intermediate position of the second air suction passage 71 upstream in the discharge direction De by a predetermined length. In the discharge direction De, an upstream end portion of the second bypass passage 73 faces a downstream end portion of the first bypass passage 68. The second bypass passage 73 exhibits a shape capable of receiving the air discharged in the discharge direction De from the downstream end portion of the first bypass passage 68. The second bypass passage 73 may not necessarily exhibit a tubular shape as long as the second bypass passage 73 can receive the air discharged in the discharge direction De from the downstream end of the first bypass passage 68. The second bypass passage 73 may be, for example, a guide plate exhibiting a plate shape extending at an angle capable of receiving the air as shown in FIG. 4.

As illustrated in FIG. 4, the liquid ejection apparatus 11 includes a switching mechanism 80 capable of switching a discharge destination of the air in the middle of the bypass passage 67. Specifically, the switching mechanism 80 is configured to be able to switch the exhaust destination of the air discharged from the first bypass passage 68. The switching mechanism 80 is configured to be switchable between an open state in which the bypass passage 67 communicates with the second air suction passage 71 and a closed state in which the bypass passage 67 does not communicate with the second air suction passage 71. In other words, the switching mechanism 80 is configured to be switchable between an open state in which the air discharged from the first bypass passage 68 can be fed into the second air suction passage 71 and a closed state in which the air is not fed into the second air suction passage 71.

Specifically, the switching mechanism 80 includes an on-off plate 81. The on-off plate 81 is configured to be movable between a closed position indicated by a solid line in FIG. 4 and an open position indicated by a dashed-two dotted line in FIG. 4. When the on-off plate 81 is at the closed position, the on-off plate 81 closes the communication passage between the first bypass passage 68 and the second bypass passage 73. When the on-off plate 81 is at the closed position, the air discharged from the first bypass passage 68 is discharged into the apparatus main body 12 along a surface of the on-off plate 81 at the closed position.

On the other hand, when the on-off plate 81 of the switching mechanism 80 is at the open position, the first bypass passage 68 and the second bypass passage 73 communicate with each other. Therefore, the air discharged from the first bypass passage 68 is fed into the second air suction passage 71 through the second bypass passage 73. That is, when the on-off plate 81 is at the open position, the air discharged from the first bypass passage 68 is fed into the second air suction passage 71 by being received by the second bypass passage 73.

As shown in FIG. 4, the first bypass passage 68 has a flow rate acceleration portion 69 exhibiting a tapered shape in which the passage cross-sectional area decreases downstream in a downstream portion in the discharge direction De. As described above, the portion of the bypass passage 67 reaching the switching mechanism 80 in the discharge direction De is formed in a tapered shape in which the passage cross-sectional area is smaller in a downstream portion than in an upstream portion. The flow rate of the air discharged from the downstream end of the first bypass passage 68 is accelerated by the flow rate acceleration portion 69 exhibiting a tapered shape. Therefore, air high in flow rate is discharged from the downstream end of the first bypass passage 68.

The flow rate acceleration portion 69 exhibiting the tapered shape also functions as a guide that directs the air flowing into the second air suction passage 71 in the feeding direction Df. The flow rate acceleration portion 69 guides the air flowing into the second air suction passage 71 from the first bypass passage 68 so as to be directed in the direction along the feeding direction Df by the inclination angle of the inner surface. Further, the second bypass passage 73 and the on-off plate 81 at the closed position also guide the air along the orientation direction.

### Configuration of Switching Mechanism 80

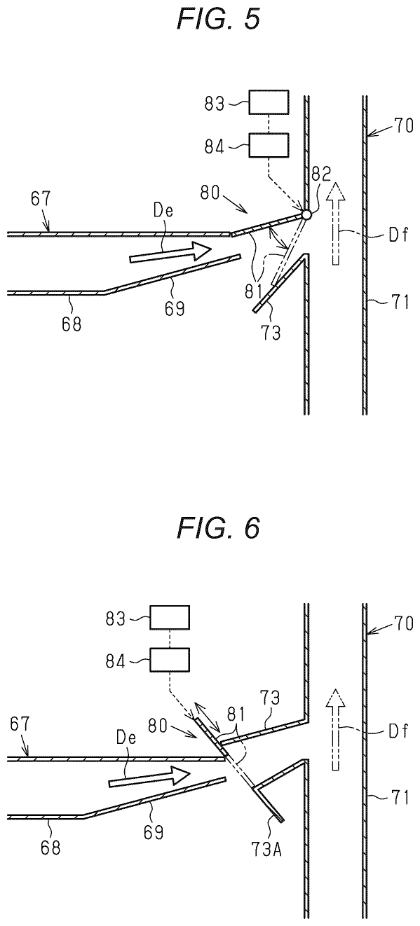

Then, a configuration of the switching mechanism 80 will be described with reference to FIG. 5.

The on-off plate 81 provided to the switching mechanism 80 may be of a rotary type or a slide type. The switching mechanism 80 employs the rotary type in which the switching operation of the on-off plate 81 illustrated in FIG. 5 includes a rotation. Further, the switching mechanism 80 may adopt a slide type in which the switching operation of the on-off plate 81 is illustrated in FIG. 6 includes a slide. The configuration of each of the switching mechanism 80 of the rotary type and the switching mechanism 80 of the slide type will hereinafter be described.

First, the configuration of the switching mechanism 80 of the rotary type will be described with reference to FIG. 5. The switching mechanism 80 illustrated in FIG. 5 includes the on-off plate 81 of the rotary type. The on-off plate 81 is shaped like a plate having a predetermined shape. The on-off plate 81 is provided to be rotatable about a rotating shaft 82 within a predetermined angle range. The air high in flow rate is discharged from the downstream end of the flow rate acceleration portion 69 having a tapered shape formed in the downstream portion of the first bypass passage 68.

The on-off plate 81 is disposed so as to be rotatable to a position opposed to the downstream end of the flow rate acceleration portion 69. The on-off plate 81 is rotatable between the closed position indicated by a dashed-two dotted line in FIG. 5 and the open position indicated by a solid line in FIG. 5. The liquid ejection apparatus 11 includes an actuator 83 which is a drive source for opening and closing the on-off plate 81, and a power transmission unit 84 for converting power of the actuator 83 into opening and closing operations of the on-off plate 81. The on-off plate 81 is opened or closed by transmitting forward or reverse power from the actuator 83 to the rotating shaft 82 of the on-off plate 81.

When the on-off plate 81 is located at the closed position indicated by the dashed-two dotted line in FIG. 5, the communication between the bypass passage 67 and the second air suction passage 71 is blocked. When the on-off plate 81 is located at the closed position, the air discharged from the first bypass passage 68 toward the discharge direction De is guided along the surface of the on-off plate 81 toward an exhaust direction in which the air thus discharged is exhausted into the apparatus main body 12.

When the on-off plate 81 is located at the open position indicated by the solid line in FIG. 5, the bypass passage 67 and the second air suction passage 71 communicate with each other. Therefore, when the on-off plate 81 is located at the open position, the air which is discharged from the first bypass passage 68 toward the discharge direction De and is high in flow rate flows into the second air suction passage 71 via the second bypass passage 73.

Further, the switching mechanism 80 of the slide type illustrated in FIG. 6 includes an on-off plate 81 disposed so as to be slidable in a predetermined direction. The on-off plate 81 has a size sufficient to close the second bypass passage 73.

The on-off plate 81 can move, by sliding, between a closed position indicated by a dashed-two dotted line in FIG. 6 and an open position indicated by a solid line in FIG. 6. The liquid ejection apparatus 11 includes an actuator 83 that is a drive source for opening and closing the on-off plate 81, and a power transmission unit 84 that converts the power of the actuator 83 into sliding motion of the on-off plate 81. The on-off plate 81 is opened and closed by the power of the actuator 83 for sliding the on-off plate 81 in a predetermined direction.

When the on-off plate 81 of the switching mechanism 80 is located at the closed position indicated by the dashed-two dotted line in FIG. 6, the second bypass passage 73 is closed. The air discharged from the first bypass passage 68 is exhausted into the apparatus main body 12 along the surface of the on-off plate 81 located at the closed position. The second bypass passage 73 has a guide plate portion 73A that guides the air, which is discharged from the first bypass passage 68, into the apparatus main body 12 in cooperation with the on-off plate 81 located at the closed position.

When the on-off plate 81 of the switching mechanism 80 is located at the open position indicated by the solid line in FIG. 6, the air discharged from the first bypass passage 68 flows into the second air suction passage 71 through the second bypass passage 73.

### Electrical Configuration of Liquid Ejection Apparatus 11

Then, an electrical configuration of the liquid ejection apparatus 11 will be described with reference to FIG. 7. As illustrated in FIG. 7, the liquid ejection apparatus 11 includes the controller 100 and the drive board 50 described above. The controller 100 and an ejection controller 52 are communicably coupled to each other.

The controller 100 performs overall control of the liquid ejection apparatus 11. The controller 100 is electrically coupled to a first detector 101 and a second detector 102, which are examples of a detector, via an input interface (not illustrated). The first detector 101 detects the temperature in the housing unit 51. The second detector 102 detects the size of the medium 16.

In addition, the controller 100 is electrically coupled to the conveyance unit 20, the charging unit 33, the removal unit 35, the first fan 63, the second fan 72, and the switching mechanism 80 via an output interface (not illustrated). The controller 100 controls the conveyance unit 20, the charging unit 33, the removal unit 35, the first fan 63, the second fan 72, and the switching mechanism 80.

The controller 100 can be configured as a circuit including α: one or more processors that carry out various types of processing in accordance with a computer program, β: one or more dedicated hardware circuits that carry out at least some of the various types of processing, or γ: a combination of α and β. The hardware circuit is, for example, an application specific integrated circuit. The processor includes a CPU and a storage unit including memory devices such as a RAM and a ROM. The storage unit stores program codes or commands configured to be executed by the CPU. The memory device, that is, a computer-readable medium includes any readable medium that can be accessed by a general-purpose or dedicated computer.

The controller 100 stores a program in the storage unit of the computer. In the controller 100, the computer executes the program. The controller 100 includes a conveyance controller 111, a printing speed acquisition unit 112, and an abnormality detector 113, which are configured by software.

The print data PD is input to the controller 100 from a host device (not shown). The print data PD includes print condition information and image data. The print condition information includes information such as a type of the medium 16 (medium type), a medium size, a print mode, and a print color (color or monochrome). The image data is dot data including, for each pixel, a density value (pixel value) corresponding to an ejection amount of a liquid such as ink which the liquid ejection unit 40 ejects from a plurality of nozzles.

The drive board 50 includes the ejection controller 52. The ejection controller 52 controls the liquid ejection unit 40. The image data and so on are input to the ejection controller 52 from the controller 100. The ejection controller 52 ejects droplets from the nozzles with a discharge amount corresponding to the density value of each pixel (dot) of the image data. A character or an image is printed on the medium 16 with a plurality of dots formed by a plurality of droplets landing on the medium 16. The pixel value of the image data is a value corresponding to the amount of the liquid ejected onto the medium 16. The larger the amount of liquid to be ejected, the more power is consumed to drive an ejection element.

The ejection controller 52 drives the ejection element provided to each of the nozzles of the liquid ejection unit 40 based on the image data. The ejection element is driven to eject the liquid from the nozzle. Examples of the ejection element include a piezoelectric element, an electrostatic element, and a heater element. The ejection controller 52 controls each ejection element by outputting a duty value (duty ratio), which is a ratio of applied power to maximum power, to the ejection element as a command value.

The conveyance controller 111 controls the conveyance unit 20. The conveyance controller 111 controls the drive of the conveyance unit 20 at a driving speed corresponding to the print mode. Accordingly, the medium 16 is conveyed at a conveyance speed corresponding to the print mode.

The printing speed acquisition unit 112 acquires information on the printing speed based on the print data PD. The print data PD includes information of the print mode as one of pieces of the print condition information. A plurality of print modes including a first print mode and a second print mode is prepared as the print mode. The first print mode is, for example, a high-definition print mode, and the second print mode is, for example, a high-speed print mode. Second printing speed in the second print mode is higher than first printing speed in the first print mode. There is a tendency that the higher the printing speed is, the more apt to generate heat the drive board 50 is.

The abnormality detector 113 detects an abnormality such as a failure of a component of various drive systems in the liquid ejection apparatus 11. The abnormality detector 113 detects an abnormality of, for example, the first fan 63, the second fan 72, and the conveyance motor. The abnormality detector 113 detects an abnormality such as a failure of the second fan 72 when a detection signal indicating that a rotation sensor (not illustrated) capable of detecting the rotation of the second fan 72 does not detect the rotation is input although the drive command value is output to the second fan 72. Alternatively, when the temperature detected by the first detector 101 does not decrease even though the drive command value is output to the second fan 72, an abnormality such as a failure of the second fan 72 may be detected.

When the liquid ejection unit 40 performs the liquid ejection operation in a state where an abnormality occurs in the second fan 72, the controller 100 stops the second fan 72 and sets the switching mechanism 80 to the open state. That is, when the controller 100 detects the abnormality of the second fan 72, the controller 100 sets the switching mechanism 80 to the open position in a state where the second fan 72 is stopped when making the liquid ejection unit 40 perform the liquid ejection operation based on the print data PD. When the liquid ejection operation is performed, the controller 100 drives the first fan 63 to collect the mist. Therefore, the air discharged by the first fan 63 flows from the bypass passage 67 into the second air suction passage 71 via the switching mechanism 80 set in the open state.

The first detector 101 detects the temperature of the drive board 50. The first detector 101 may indirectly detect the temperature of the drive board 50 by detecting the temperature in the housing unit 51. The first detector 101 may directly detect the temperature of the drive board 50. The first detector 101 may be, for example, a temperature sensor or a hygrothermal sensor. Further, the first detector 101 may be provided to the drive board 50.

The controller 100 may control the switching mechanism 80 based on the temperature detected by the first detector 101. The controller 100 keeps the switching mechanism 80 at the closed position while the temperature detected by the first detector 101 is equal to or lower than a temperature threshold. On the other hand, the controller 100 may switch the switching mechanism 80 from the closed position to the open position when the temperature detected by the first detector 101 exceeds the temperature threshold.

When the switching mechanism 80 is in the open state, the controller 100 may drive the first fan 63 at an operating speed corresponding to the temperature detected by the first detector 101. In this case, the controller 100 may increase the operating speed of the first fan 63 stepwise or continuously as the temperature detected by the first detector 101 increases. When the switching mechanism 80 is in the open state, the controller 100 may drive the first fan 63 at a second operating speed higher than a first operating speed when the temperature detected by the first detector 101 is a second temperature higher than a first temperature at which the controller 100 drives the first fan 63 at the first operating speed. Due to this control, when the switching mechanism 80 is in the open state, the first fan 63 is driven at a higher operating speed when the temperature detected by the first detector 101 is the second temperature higher than the e first temperature than when the temperature detected is the first temperature.

The second detector 102 may be a width sensor that detects the width size of the medium 16. In the liquid ejection unit 40, the larger the size of the medium 16 as an ejection target of the liquid is, the larger the number of nozzles used for ejecting the liquid becomes, and therefore, the more apt to generate heat the drive board 50 is. In the liquid ejection unit 40, when the size of the medium 16 is a first size, the drive board 50 is apt to generate heat when printing is performed on a medium having a second size larger than the first size. The controller 100 may switch the switching mechanism 80 from the closed position to the open position when the size of the medium 16 exceeds a size threshold.

When the switching mechanism 80 is in the open state, the controller 100 may drive the first fan 63 at a higher operating speed when the size of the medium 16 is the second size than when the size of the medium 16 is the first size. In this case, the controller 100 may increase the operating speed of the first fan 63 stepwise or continuously as the size of the medium 16 detected by the second detector 102 increases.

The controller 100 may control the switching mechanism 80 based on a duty value. In this case, an average duty value calculated from density values of all pixels or some pixel groups of the image data may be used as the duty value. The average duty value may be, for example, an average duty value per image or an average duty value of a plurality of images. The controller 100 may switch the switching mechanism 80 from the closed state to the open state when the duty value exceeds a threshold. Further, when the duty value exceeds the threshold, the controller 100 may perform control to increase the operating speed of the first fan 63.

The controller 100 may control the switching mechanism 80 in accordance with the print mode or the printing speed. The controller 100 may keep the switching mechanism 80 at the closed position in the first print mode. The controller 100 may switch the switching mechanism 80 from the closed position to the open position in the second print mode. The controller 100 may control opening and closing of the switching mechanism 80 in accordance with the printing speed acquired from the print mode. The controller 100 may keep the switching mechanism 80 at the closed position at the first printing speed. The controller 100 may switch the switching mechanism 80 from the closed position to the open position at the second printing speed that is higher than the first printing speed or causes a higher temperature of the drive board 50.

When the switching mechanism 80 is in the open state, the controller 100 may drive the first fan 63 at an operating speed corresponding to the print mode or the printing speed. In this case, the controller 100 may increase the operating speed of the first fan 63 stepwise or continuously as the printing speed corresponding to the print mode or the printing speed itself increases. When the switching mechanism 80 is in the open state, the controller 100 may drive the first fan 63 at a higher operating speed when the printing speed is the second printing speed higher than the first printing speed than when the printing speed is the first printing speed.

The detected temperature, the duty value, the print mode (or the printing speed), the size of the medium, and so on described above are parameters that affect the heat generation of the drive board 50. The controller 100 may control the switching mechanism 80 based on one parameter or a plurality of parameters out of these parameters. When the switching mechanism 80 is in the open state, the controller 100 may control the operating speed of the first fan 63 based on one parameter or a plurality of parameters out of these parameters.

### Functions of First Embodiment

The functions of the liquid ejection apparatus 11 in the present embodiment will be described. Note that the description will hereinafter be presented citing an example in which the controller 100 uses the detection temperature of the first detector 101 as a parameter for controlling the switching mechanism 80.

During printing, the liquid ejection unit 40 performs printing on the medium 16 by ejecting the liquid from the nozzles. When the liquid is ejected from the nozzles, mist is generated. The mist located around the liquid ejection unit 40 is collected by the mist collection device 60. The suction nozzle portion 66 suctions the air located between the ejection head 41 and the support unit 45 together with the mist by the first fan 63 being driven. The air from which the mist was collected by the capturing unit 64 through the first air suction passage 61 is discharged from the first fan 63 through the first bypass passage 68. When the switching mechanism 80 is located at the closed position, the air discharged from the first bypass passage 68 is discharged into the apparatus main body 12 along the surface of the on-off plate 81 located at the closed position. Further, the air thus discharged is discharged to the outside from the vent hole of the apparatus main body 12.

Further, during printing, the air-cooling device 70 is driven. When the second fan 72 is driven, the air suctioned from the suction port 71A flows into the housing unit 51 through the second air suction passage 71. The drive board 50 that generates heat during printing is cooled by the air flowing through the housing unit 51 from the intake port 51A toward the exhaust port 51B.

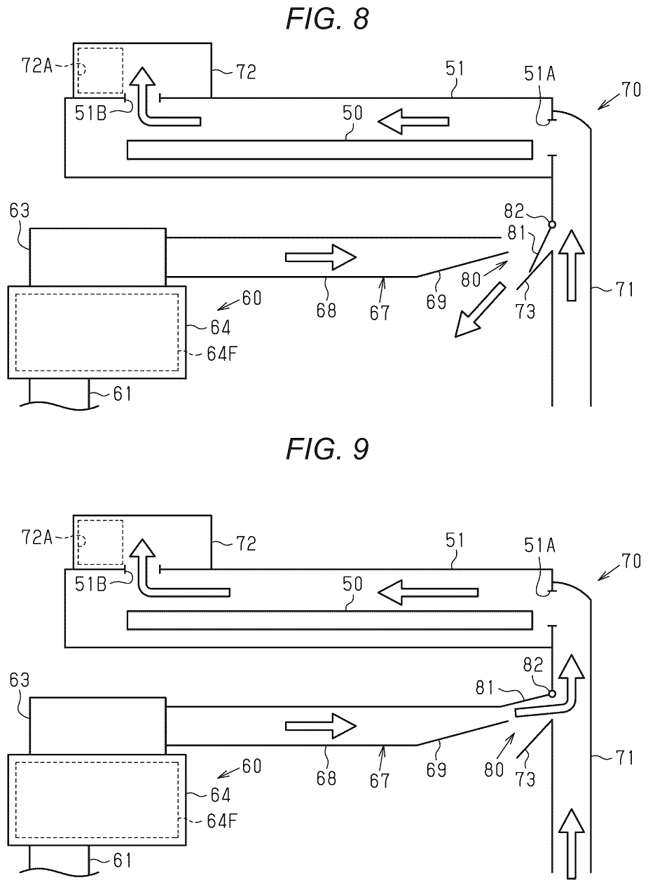

When the temperature in the housing unit 51 detected by the first detector 101 is equal to or lower than the temperature threshold, the controller 100 sets the switching mechanism 80 to the closed state as illustrated in FIG. 8. Therefore, the air discharged from the first fan 63 is guided by the surface of the on-off plate 81 located at the closed position to be exhausted into the apparatus main body 12.

The controller 100 switches the switching mechanism 80 from the closed state to the open state as illustrated in FIG. 9 when the detected temperature in the housing unit 51 detected by the first detector 101 exceeds the temperature threshold. That is, the controller 100 moves the on-off plate 81 from the closed position shown in FIG. 8 to the open position shown in FIG. 9. Therefore, the air discharged from the first fan 63 through the first bypass passage 68 flows into the second air suction passage 71. Therefore, a flow of the air suctioned by the second fan 72 and a flow of the air discharged from the first fan 63 are merged and sent into the housing unit 51.

Since the flow rate of the air which cools the drive board 50 increases, the cooling effect of the drive board 50 is enhanced. Therefore, an excessive rise in temperature of the drive board 50 is prevented. When the temperature detected by the first detector 101 becomes equal to or lower than the temperature threshold, the controller 100 restores the switching mechanism 80 from the open state to the closed state. In this way, by the controller 100 controlling opening and closing of the switching mechanism 80 in accordance with the detected temperature, the drive board 50 can be effectively cooled with the air at an appropriate flow rate in accordance with the heat generation.

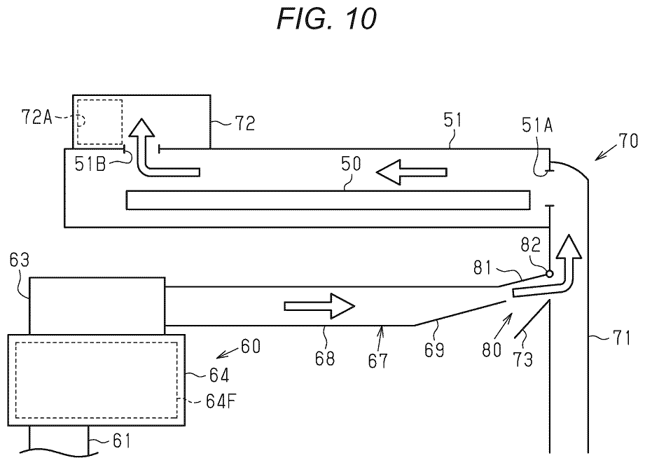

On the other hand, when the controller 100 detects an abnormality such as a failure of the second fan 72, the controller 100 stops the second fan 72. Further, as shown in FIG. 10, the controller 100 switches the switching mechanism 80 from the closed state to the open state. The air discharged from the first fan 63 through the first bypass passage 68 flows into the second air suction passage 71. On this occasion, the flow of the air high in flow rate can be caused to flow into the second air suction passage 71 by the flow rate acceleration portion 69 exhibiting a tapered shape. Since the flow of the air flows into the second air suction passage 71 toward a direction along the feeding direction Df, the flow of the air is fed from the second air suction passage 71 into the housing unit 51. Therefore, even when an abnormality occurs in the second fan 72, the drive board 50 in the housing unit 51 can be cooled.

Further, when the switching mechanism 80 is in the open state, the controller 100 may control the operating speed of the third fan 92 based on at least one parameter out of the parameters such as the detected temperature, the duty value, the printing speed, and the size of the medium.

When the switching mechanism 80 is in the open state, the controller 100 may increase the operating speed of the first fan 63 from the first speed to the second speed when the detected temperature exceeds the temperature threshold. When the switching mechanism 80 is in the open state, the controller 100 may increase the operating speed of the first fan 63 from the first speed to the second speed when the duty value exceeds the threshold. Further, when the switching mechanism 80 is in the open state, the controller 100 may increase the operating speed of the first fan 63 from the first speed to the second speed when the size of the medium detected by the second detector 102 exceeds the size threshold. Further, when the switching mechanism 80 is in the open state, the controller 100 may increase the operating speed of the first fan 63 from the first speed to the second speed when the printing speed corresponding to the print mode exceeds the threshold. Note that the controller 100 may use the print mode as a determination target instead of the printing speed.

In these cases, as the operating speed of the first fan 63 increases from the first speed to the second speed, the flow rate of the air flowing in the housing unit 51 increases. Therefore, even when the amount of heat generation of the drive board 50 increases due to the fact that the parameter values (the detected temperature, the duty value, the printing speed, the size of the medium, and so on) exceed the thresholds, the drive board 50 can appropriately be cooled. Note that the controller 100 may control the operating speed of the third fan 92 in a plurality of, that is, three or more stages of three or more stages by setting a plurality of, that is, three or more thresholds. Further, the controller 100 may control the second fan 72 at a plurality of stages of operating speeds based on the parameters described above.

### Advantages of First Embodiment

Advantages of the present embodiment will be described.

(1-1) The switching mechanism 80 configured to be switched between the open state in which the bypass passage 67 is made to communicate with the second air suction passage 71 and the closed state in which the bypass passage 67 is not made to communicate with the second air suction passage 71 is provided. Therefore, by switching the switching mechanism 80 from the closed state to the open state, the air discharged by the first fan 63 can be used to cool the drive board 50. Therefore, even when the flow rate of the second fan 72 is insufficient due to the abnormality or the capability limit, the drive board 50 can be appropriately cooled with the air having an appropriate flow rate. For example, since the liquid ejection operation can be performed even when the second fan 72 is abnormal, the occurrence of downtime can be prevented. Further, even when the flow rate is insufficient due to the limit of the capacity of the second fan 72, the air discharged from the first fan 63 can be used to cool the drive board 50. Therefore, it is possible to suppress an increase in size due to an increase in capacity of the second fan 72 dedicated to cooling the drive board.

(1-2) When the liquid ejection unit 40 performs the liquid ejection operation in a state where an abnormality occurs in the second fan 72, the second fan 72 is stopped, and the switching mechanism 80 is set to the open state. Therefore, it is possible to prevent the occurrence of downtime in which the liquid ejection operation cannot be performed due to the abnormality of the second fan 72.

(1-3) The controller 100 sets the switching mechanism 80 to the open state when the temperature detected by the first detector 101 that detects the temperature in the housing unit 51 in which the drive board 50 is housed exceeds the temperature threshold. Therefore, when the temperature in the housing unit 51 exceeds a target temperature, the cooling effect of the drive board 50 can be enhanced using the air fed by the first fan 63. Therefore, it is possible to shorten the time required to lower the temperature in the housing unit 51 to the target temperature. For example, the time during which the drive board 50 is exposed to the temperature exceeding the target temperature can be shortened.

(1-4) The first fan 63 is a mist collecting fan that generates suction force for collecting the mist generated when the liquid ejection unit 40 ejects the liquid. According to this configuration, the mist generated when the liquid ejection unit 40 ejects the liquid can be collected, and further, the air discharged by the mist collecting fan can be used to cool the drive board 50. Therefore, it becomes possible to reduce the size of the second fan 72 dedicated to cooling the drive board and perform the liquid ejection operation when the second fan 72 fails using the fan 63 which is existing or provided for the purpose of adding another function without adding a new fan.

(1-5) When the switching mechanism 80 is in the open state, the first fan 63 is driven at a higher operating speed when the detected temperature detected by the first detector 101 is a second temperature higher than the first temperature than when the detected temperature is the first temperature. According to the configuration described above, when the switching mechanism 80 is in the open state, since the first fan 63 is driven at an operating speed corresponding to the detected temperature in the housing unit 51, it is possible to feed the air to the drive board 50 at a flow rate appropriate for cooling.

(1-6) A portion of the bypass passage 67 which reaches the switching mechanism 80 in the discharge direction De is formed in a tapered shape in which the passage cross-sectional area is smaller in a downstream portion than in an upstream portion. In the present embodiment, the downstream portion of the first bypass passage 68 is formed in the tapered shape. Therefore, when the switching mechanism 80 is in the open state, it is possible to suppress a decrease in the flow rate of the air flowing from the bypass passage 67 into the second air suction passage 71. Further, the flow rate acceleration portion 69 having the tapered shape guides the airflow in a direction along the feeding direction Df. Therefore, it is possible to prevent the airflow from the bypass passage 67 from merging in a manner of interfering with the flow of the air suctioned from the second suction port 71A in the feeding direction Df. In addition, when an abnormality occurs in the second fan 72, it is possible to feed an airflow high in flow rate directed in the direction along the feeding direction Df from the bypass passage 67 to the second air suction passage 71.

(1-7) The switching mechanism 80 includes the on-off plate 81. The on-off plate 81 is of a rotary type or a slide type. According to this configuration, it is easy to switch between merging and non-merging of the air with a simple configuration by rotation or slide of the on-off plate 81.

### Second Embodiment

Then, a second embodiment of the liquid ejection apparatus will be described with reference to the drawings. The liquid ejection apparatus 11 according to the second embodiment includes a foreign matter collection device 90 instead of the mist collection device 60. Therefore, in the second embodiment, a third fan 92 which is a suction source of the foreign matter collection device 90 is used as an example of the first suction source instead of the first fan 63 which is the suction source of the mist collection device 60 in the first embodiment. Other configurations are basically the same as those of the first embodiment. Therefore, the same elements as those in the first embodiment are denoted by the same reference numerals to thereby omit redundant description thereof.

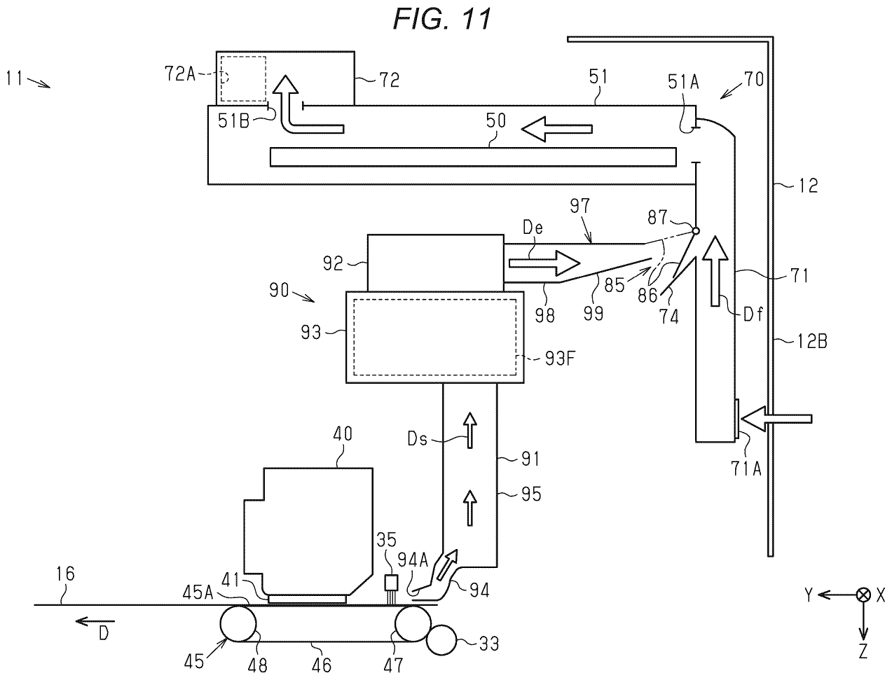

A device that is provided to the liquid ejection apparatus 11 and cools the drive board 50 will hereinafter be described with reference to FIG. 11. As illustrated in FIG. 11, the liquid ejection apparatus 11 includes the foreign matter collection device 90 and the air-cooling device 70. The foreign matter collection device 90 is a device that collects foreign matter such as paper dust from the medium 16. The foreign matter collection device 90 includes a first air suction passage 91 and the third fan 92 as an example of the first suction source.

The third fan 92 generates suction force capable of suctioning air into the first air suction passage 91. The third fan 92 is a foreign matter collecting fan that collects foreign matter from the removal unit 35. An upstream end portion of the first air suction passage 91 is coupled to an intake port of the third fan 92 via a capturing unit 93.

The first air suction passage 61 suctions air at a position of at least one of an upstream portion and a downstream portion of the liquid ejection unit 40 in a direction of a relative movement between the medium 16 supported by the support unit 45 and the liquid ejection unit 40, and causes the air to flow downstream in the suction direction Ds. The direction of the relative movement is, for example, the conveyance direction D. The first air suction passage 91 suctions the air located between the support unit 45 and the liquid ejection unit 40 and causes the air to flow downstream in the suction direction Ds. The first air suction passage 91 may be capable of suctioning the air located between the support unit 45 and the liquid ejection unit 40 at a position upstream of the liquid ejection unit 40 in the conveyance direction D. In particular, the first air suction passage 91 suctions foreign matter such as paper dust adhering to the removal unit 35 to thereby collect the foreign matter such as paper dust. The first air suction passage 91 includes a suction nozzle portion 94 and a first suction duct 95.

The suction nozzle portion 94 is disposed at a position upstream of the ejection head 41 in the conveyance direction D. The suction nozzle portion 94 is disposed at a predetermined position in the width direction X. The suction nozzle portion 94 extends obliquely downward toward the removal unit 35. The suction nozzle portion 94 has a third suction port 94A that opens at a lower end portion. The third suction port 94A is disposed at a height position in the vertical direction Z where the foreign matter such as paper dust adhering to the removal unit 35 can be suctioned. The third suction port 94A is located in the vertical direction Z, for example, above the support surface 45A that is the upper surface of the support unit 45 and below the upper surface of the liquid ejection unit 40. In the example illustrated in FIG. 11, the third suction port 94A is located above the nozzle surface that is the lower surface of the ejection head 41. For example, the third suction port 94A may be located above the ejection head 41.

The liquid ejection apparatus 11 includes a removal unit 35 that removes foreign matter from the medium 16. The removal unit 35 includes a destaticizing brush capable of coming into contact with the support surface 45A of the conveyance belt 46. The destaticizing brush has a predetermined length over the conveyance belt 46 in the width direction X. The destaticizing brush is disposed over a region slightly wider than the maximum width of the medium 16. The removal unit 35 removes foreign matter such as paper dust from the surface of the medium 16 with the destaticizing brush that comes into contact with the entire area of the surface of the medium 16. The destaticizing brush may be configured to be movable in the width direction X.

The destaticizing brush may be configured with a long and flexible member wound around a pair of pulleys located at both sides in the width direction X of the conveyance belt 46. The destaticizing brush having an elongated shape may be configured to be capable of reciprocating in the width direction X while keeping a state of being in contact with the surface of the medium 16 on the conveyance belt 46 by rotating at least one pulley with the power of a motor (not illustrated). Further, the destaticizing brush may be configured to move in one direction of the width direction X by rotating along a circulation path instead of reciprocating in the width direction X.

The liquid ejection apparatus 11 includes a cleaning unit (not illustrated) that scrapes off the foreign matter such as paper dust from the destaticizing brush that is moving. The cleaning unit is provided at, for example, one position within the movement range of the destaticizing brush in the width direction X. The foreign matter such as paper dust removed from the medium 16 by the destaticizing brush adheres to the destaticizing brush. The cleaning unit can come into contact with the destaticizing brush at a predetermined position in the width direction X. The cleaning unit scrapes off the foreign matter such as paper dust from the destaticizing brush by coming into contact with the destaticizing brush in motion. The foreign matter such as paper dust adhering to the destaticizing brush is collected at a cleaning position of the cleaning unit.

The third suction port 94A of the foreign matter collection device 90 is directed to the cleaning position. The foreign matter collection device 90 collects the foreign matter such as paper dust scraped by the cleaning unit by suctioning the foreign matter through the third suction port 94A.

The first suction duct 95 extends from the first chamber 19A to the second chamber 19B across the partition plate 12F. A downstream end portion of the first suction duct 95 is coupled to the capturing unit 93 disposed in the second chamber 19B. The capturing unit 93 captures the foreign matter such as paper dust contained in the air suctioned through the first air suction passage 91. The capturing unit 93 includes a filter 93F inside.

The third fan 92 is coupled to the capturing unit 93. An intake port of the third fan 92 and an exhaust port of the capturing unit 93 communicate with each other. The third fan 92 suctions the air from which the foreign matter was removed by the filter 93F of the capturing unit 93. The third fan 92 exhausts the suctioned air to the bypass passage 97.

The configurations of the drive board 50 and the air-cooling device 70 are the same as those in the first embodiment. The drive board 50 is housed in the housing unit 51. The housing unit 51 has the intake port 51A and the exhaust port 51B on both sides in the longitudinal direction (e.g., the Y direction).

The air-cooling device 70 includes the second air suction passage 71 and the second fan 72 as an example of the second suction source. The second air suction passage 71 feeds external air to the drive board 50. A downstream end portion of the second air suction passage 71 is coupled to the intake port 51A of the housing unit 51 in which the drive board 50 is housed. The second air suction passage 71 has the second suction port 71A that suctions air outside the apparatus main body 12. The air suctioned through the second air suction passage 71 cools the drive board 50 in the housing unit 51. The air-cooling device 70 cools the drive board 50 by the air-cooling method.

The bypass passage 97 includes a first bypass passage 98 and a second bypass passage 74. An upstream end portion of the first bypass passage 98 is coupled to an exhaust port of the third fan 92. The second bypass passage 74 communicates with the second air suction passage 71. A downstream end of the first bypass passage 98 and an upstream end of the second bypass passage 74 face each other.

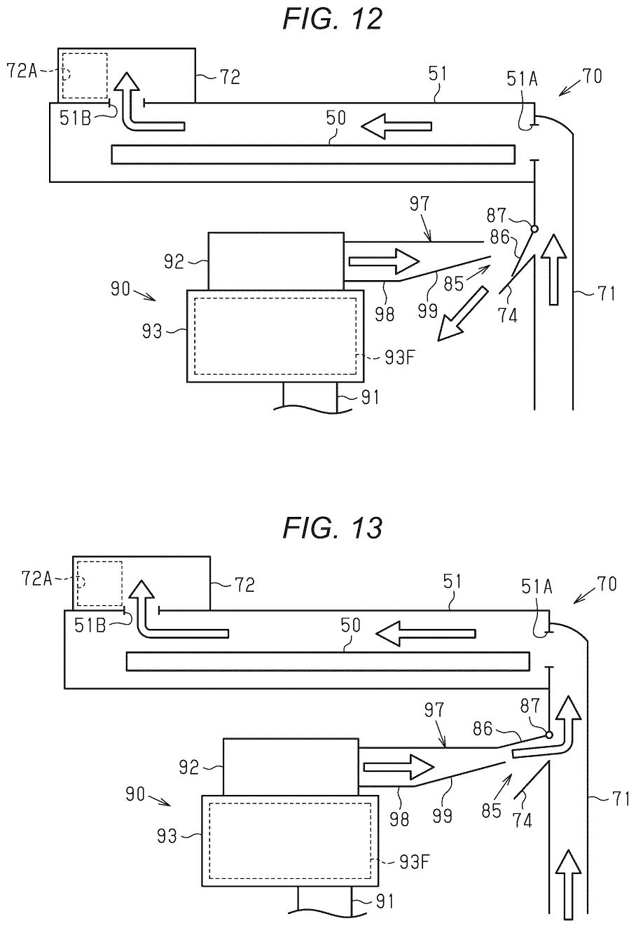

A switching mechanism 85 is disposed between the first bypass passage 98 and the second bypass passage 74. The switching mechanism 85 is configured to be switchable between an open state in which the bypass passage 97 communicates with the second air suction passage 71 and a closed state in which the bypass passage 97 does not communicate with the second air suction passage 71. Specifically, the switching mechanism 85 can switch between the open state in which a downstream end portion of the first bypass passage 98 and an upstream end portion of the second bypass passage 74 communicate with each other and the closed state in which the downstream end portion of the first bypass passage 98 and the upstream end portion of the second bypass passage 74 do not communicate with each other. The switching mechanism 85 includes an on-off plate 86 movable between a closed position and an open position. The basic configuration of the switching mechanism 85 is similar to that of the switching mechanism 80 shown in FIGS. 5 and 6. The switching mechanism 85 illustrated in FIG. 12 includes, for example, an on-off plate 86 disposed to be rotatable about a rotating shaft 87. The switching mechanism 85 is not limited to a rotary type and may be a slide type.

The first bypass passage 98 has a flow rate acceleration portion 99 in a downstream portion in the discharge direction De. That is, a portion of the bypass passage 97 reaching the switching mechanism 85 in the discharge direction De is formed in a tapered shape in which the passage cross-sectional area is smaller in a downstream portion than in an upstream portion.

The flow rate acceleration portion 99 exhibiting the tapered shape also functions as a guide that directs the air flowing into the second air suction passage 71 in the feeding direction Df. The flow rate acceleration portion 99 guides the air flowing into the second air suction passage 71 from the first bypass passage 98 so as to be directed in the direction along the feeding direction Df due to the inclination angle of the inner surface thereof. The second bypass passage 74 and the on-off plate 86 located at the closed position also guide the air along the orientation direction.

The contents of the control in which the controller 100 switches the switching mechanism 85 between the closed state and the open state are basically the same as those in the first embodiment. When the switching mechanism 85 is in the open state, the control content of the controller 100 for switching the operating speed of the third fan 92 is basically the same as that in the first embodiment except that the control target is changed from the first fan 63 to the third fan 92.

### Functions of Second Embodiment

Functions of the present embodiment will be described.

While the liquid ejection apparatus 11 is powered on, the removal unit 35 removes the foreign matter such as paper dust from the medium 16. The foreign matter such as paper dust adhering to the removal unit 35 is scraped up to the cleaning position by the cleaning unit. The controller 100 drives the third fan 92 of the foreign matter collection device 90. The foreign matter such as paper dust scraped up to the cleaning position is suctioned by the suction nozzle portion 94 illustrated in FIG. 11. The air suctioned by the suction nozzle portion 94 flows to the capturing unit 93 through the first suction duct 95. The foreign matter such as paper dust contained in the air is captured by the capturing unit 93.

As shown in FIG. 12, when the switching mechanism 85 is in the closed state, the air from which the foreign matter was removed is discharged from the third fan 92 to the first bypass passage 98. The air flowing through the first bypass passage 98 is discharged into the apparatus main body 12 along the surface of the on-off plate 86 at the closed position.

Further, during printing, the air-cooling device 70 is driven. The drive board 50 that generates heat during printing is cooled by the air drawn by the suction force of the air-cooling device 70 to thereby flow through the housing unit 51. Specifically, when the second fan 72 is driven, the air suctioned from the second suction port 71A flows through the housing unit 51 to thereby cool the drive board 50.

In addition, the controller 100 performs control of switching the on-off state of the switching mechanism 80 in accordance with parameters such as a detected temperature, a size of the medium, a duty value, and a printing speed related to the heat generation state of the drive board 50. The controller 100 adjusts the flow rate of the air used for cooling the drive board 50 in accordance with the heat generation state of the drive board 50 by switching the on-off state of the switching mechanism 85. Here, an example in which the controller 100 controls opening and closing of the switching mechanism 85 based on the detected temperature will be described.

The controller 100 switches the switching mechanism 85 from the closed state to the open state as illustrated in FIG. 13 when the detected temperature in the housing unit 51 detected by the first detector 101 exceeds the temperature threshold. The air discharged from the third fan 92 flows into the second air suction passage 71 from the first bypass passage 98. The air merged in the second air suction passage 71 is sent in the feeding direction Df. Since the flow rate of the air which cools the drive board 50 increases, the cooling effect of the drive board 50 is enhanced. Therefore, an excessive rise in temperature of the drive board 50 is prevented. When the temperature detected by the first detector 101 becomes equal to or lower than the temperature threshold, the controller 100 restores the switching mechanism 85 from the open state to the closed state. In this way, by the controller 100 controlling opening and closing of the switching mechanism 85 in accordance with the detected temperature, it is possible to cause the air to flow to the drive board 50 at an appropriate flow rate. Therefore, the drive board 50 can appropriately be cooled.

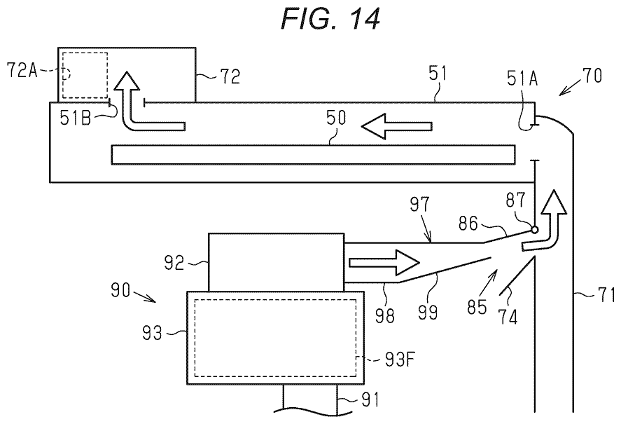

On the other hand, when the controller detects an abnormality in the second fan 72, the controller 100 stops the second fan 72 and switches the switching mechanism 85 from the closed state to the open state as shown in FIG. 14. By the air discharged from the first fan 63 flowing from the first bypass passage 68 into the second air suction passage 71, the air flows through the housing unit 51. Therefore, even when an abnormality occurs in the second fan 72, the drive board 50 can be cooled by the air flowing through the housing unit 51. Therefore, even when an abnormality occurs in the second fan 72, the liquid ejection operation of the liquid ejection unit 40 can be continued, and thus the occurrence of downtime can be suppressed.

Further, when the switching mechanism 85 is in the open state, the controller 100 may control the operating speed of the third fan 92 based on at least one parameter out of the parameters such as the detected temperature, the duty value, the printing speed, and the size of the medium. When the switching mechanism 85 is in the open state, the controller 100 may increase the operating speed of the third fan 92 from the first speed to the second speed when the value of the parameter exceeds the corresponding threshold. In this case, the flow rate of the air flowing through the housing unit 51 increases. Therefore, even when the amount of heat generated by the drive board 50 increases due to the parameter values (the detected temperature, the duty value, the printing speed, the size of the medium, and so on) that are so high as to exceed the thresholds, the drive board 50 is appropriately cooled. Note that the controller 100 may control the operating speed of the third fan 92 in a plurality of, that is, three or more stages of three or more stages by setting a plurality of, that is, three or more thresholds. Further, the controller 100 may control the second fan 72 at a plurality of stages of operating speeds based on the parameters described above.

### Advantages of Second Embodiment

According to the second embodiment, the advantages (1-1) to (1-7) of the first embodiment can similarly be obtained, and in addition, the following advantages can be obtained.

Advantages of the present embodiment will be described.

(2-1) The removal unit 35 that removes the foreign matter from the medium 16 is provided. The third fan 92 is a foreign matter collecting fan that collects foreign matter from the removal unit 35. Therefore, the foreign matter (e.g., a medium powder) can be collected from the medium 16, and the air discharged by the foreign matter collecting fan can be used to cool the drive board 50. Therefore, it becomes possible to reduce the size of the second fan 72 dedicated to cooling the drive board. In addition, since the liquid ejection operation can be performed when the second fan 72 fails, the occurrence of downtime can be suppressed.

### Third Embodiment

Then, a third embodiment of the liquid ejection apparatus will be described with reference to the drawings. The third embodiment is different from the embodiments described above in that the liquid ejection apparatus 11 includes both the mist collection device 60 and the foreign matter collection device 90. Since other configurations are basically the same as those of the first embodiment, the same reference numerals are given to the same configurations to thereby omit redundant description.

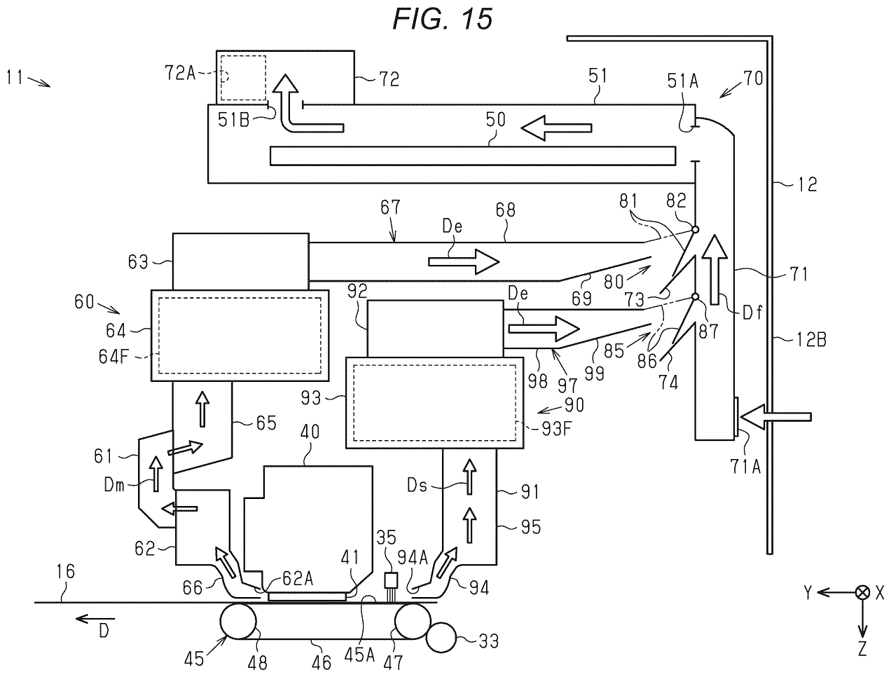

As illustrated in FIG. 15, the liquid ejection apparatus 11 includes the mist collection device 60, the foreign matter collection device 90, and the air-cooling device 70. The mist collection device 60 and the air-cooling device 70 have substantially the same configurations as those of the first embodiment. The foreign matter collection device 90 has basically the same configuration as that of the second embodiment. Further, the configurations of the bypass passage 67 and the switching mechanism 80 capable of connecting the first fan 63 and the second air suction passage 71 are substantially the same as those in the first embodiment described above. The configurations of the bypass passage 97 and the switching mechanism 85 capable of connecting the third fan 92 and the first air suction passage 91 are substantially the same as those in the second embodiment described above. The third fan 92 and the bypass passage 97 are disposed at positions different from those in the second embodiment in the vertical direction Z in order to avoid interference between the two bypass passages 67, 97.

In the example illustrated in FIG. 15, both of the two switching mechanisms 80, 85 are of the rotary type, but one or both of the switching mechanisms 80, 85 may be changed to the configuration of the slide type illustrated in FIG. 6. Note that in the present embodiment, the two switching mechanisms 80, 85 are also referred to as a first switching mechanism 80 and a second switching mechanism 85 so as to be distinguished from each other.

The mist collection device 60 has substantially the same configuration as that of the first embodiment. That is, the mist collection device 60 includes the first air suction passage 61 and the first fan 63 as an example of the first suction source. The first fan 63 is the mist collecting fan that generates the suction force when collecting the mist generated when the liquid ejection unit 40 ejects the liquid.

The liquid ejection apparatus 11 includes the bypass passage 67 and the switching mechanism 80. The bypass passage 67 is configured to be able to feed the air discharged from the first fan 63 to the second air suction passage 71. The switching mechanism 80 is configured to be switchable between an open state in which the bypass passage 67 communicates with the second air suction passage 71 and a closed state in which the bypass passage 67 does not communicate with the second air suction passage 71.

In addition, the liquid ejection apparatus 11 includes the removal unit 35 that removes foreign matter from the medium 16 and the foreign matter collection device 90. The removal unit 35 has basically the same configuration as that of the second embodiment. That is, the removal unit 35 is configured such that the destaticizing brush having a length in the width direction X of the conveyance belt 46 is movable in the width direction X. The liquid ejection apparatus 11 includes a cleaning unit (not illustrated) similar to that of the second embodiment that scrapes off the foreign matter such as paper dust from the destaticizing brush that is in motion.

The foreign matter collection device 90 has substantially the same configuration as that of the second embodiment. That is, the foreign matter collection device 90 includes the first air suction passage 91 and the third fan 92 as an example of the first suction source. The third fan 92 is the foreign matter collecting fan that collects foreign matter from the removal unit 35.

The liquid ejection apparatus 11 includes the bypass passage 97 and the second switching mechanism 85. The bypass passage 97 is configured to be able to feed the air discharged from the third fan 92 to the second air suction passage 71. The switching mechanism 85 is configured to be switchable between the open state in which the bypass passage 97 communicates with the second air suction passage 71 and the closed state in which the bypass passage 97 does not communicate with the second air suction passage 71.

As described above, in the present embodiment, a plurality of sets (two sets in this example) of the first air suction passage 61, 91, the fan 63, 92 as an example of the first suction source, the bypass passage 67, 97, and the switching mechanism 80, 85 are provided. The two switching mechanisms 80, 85 out of the plurality of sets switch between the open state and the closed state in four or three combinations.

The control of the controller 100 for switching the switching mechanism 80, 85 from the closed state to the open state is basically the same as that in the first embodiment. In addition, when at least one of the switching mechanisms 80, 85 is in the open state, the control content in which the controller 100 switches the operating speed of each of the first fan 63 and the third fan 92 is basically the same as that in each of the embodiments described above.

### Functions of Third Embodiment

Functions of the present embodiment will be described. The controller 100 switches between the open state and the closed state of the two switching mechanisms 80, 85 in four or three combinations. Hereinafter, an example in which the two switching mechanisms 80, 85 are switched in three combinations will be described. In addition, an example in which the detected temperature and the duty value are used as the parameters for controlling the opening and closing of the switching mechanisms 80, 85 will be described.

During printing, the air-cooling device 70 is driven. When the second fan 72 is driven, the air suctioned from the second suction port 71A flows in the housing unit 51 through the second air suction passage 71, and thus the drive board 50 is cooled.

Further, at least during printing, the mist collection device 60 and the foreign matter collection device 90 are driven. At least during printing, the removal unit 35 reciprocates in the width direction X, so that the foreign matter such as paper dust attached to the destaticizing brush is scraped up to the cleaning position by the cleaning unit.

The mist collection device 60 suctions the air containing the mist from the mist suction unit 62 by driving the first fan 63. The air from which the mist was captured by the capturing unit 64 is discharged from the first fan 63 through the first bypass passage 68.

The foreign matter collection device 90 suctions the foreign matter such as paper dust scraped up to the cleaning position from the suction nozzle portion 94 by driving the third fan 92. The air from which the foreign matter such as paper dust was captured by the capturing unit 93 is discharged from the third fan 92 through the first bypass passage 98.

When no abnormality occurs in the second fan 72, the controller 100 controls opening and closing of the two switching mechanisms 80, 85 in accordance with whether at least one of the detected temperature and the duty value exceeds the corresponding threshold. That is, the controller 100 controls opening and closing of the two on-off plates 81, 86.

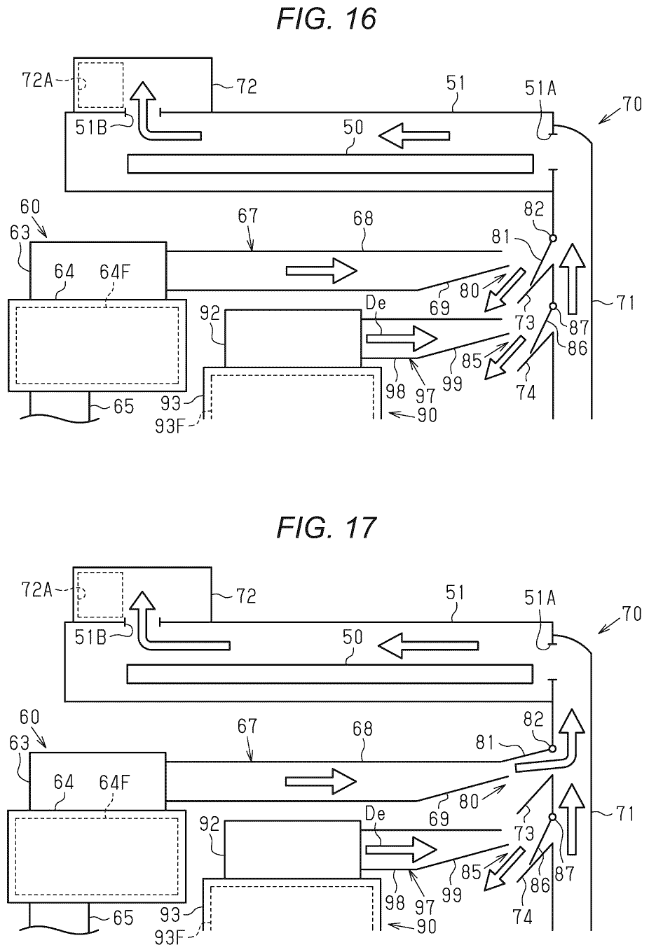

For example, when both the detected temperature and the duty value are equal to or less than the corresponding thresholds, as shown in FIG. 16, both the two switching mechanisms 80, 85 are set in the closed state. Therefore, as illustrated in FIG. 16, the air suctioned by driving the second fan 72 flows through the housing unit 51, and thus the drive board 50 is cooled. On the other hand, the air discharged from the first bypass passage 68 is guided along the surface of the on-off plate 81 located at the closed position and is exhausted into the apparatus main body 12. The air discharged from the first bypass passage 98 is also guided along the surface of the on-off plate 86 located at the closed position and is discharged into the apparatus main body 12. That is, the air exhausted by the first fan 63 and the third fan 92 is not used for cooling the drive board 50.

When one of the detected temperature and the duty value exceeds the corresponding threshold, the controller 100 switches the switching mechanism 80 from the closed state to the open state as illustrated in FIG. 17. Therefore, as shown in FIG. 17, the air suctioned by driving the second fan 72 and the air exhausted by the first fan 63 merge in the second air suction passage 71 and are fed into the housing unit 51. Since the air higher in flow rate than in the case illustrated in FIG. 16 flows through the housing unit 51, the drive board 50 is appropriately cooled. In this case, the air exhausted by the third fan 92 is not used to cool the drive board 50.

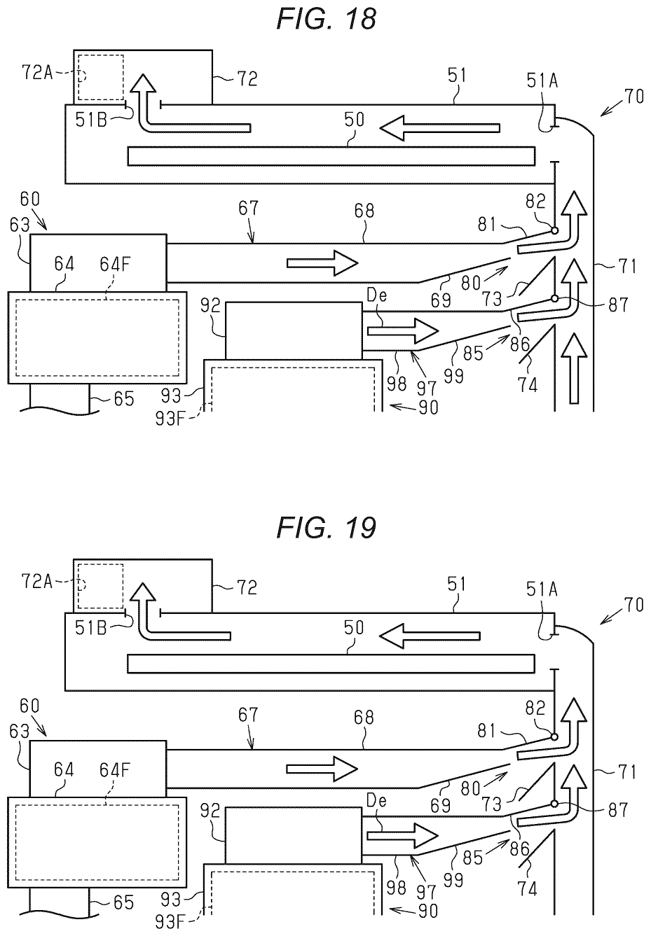

When both the detected temperature and the duty value exceed the corresponding thresholds, the controller 100 sets both the two switching mechanisms 80, 85 to the open state as illustrated in FIG. 18. Therefore, as shown in FIG. 18, the air suctioned by driving the second fan 72, the air exhausted by the first fan 63, and the air exhausted by the third fan 92 are merged in the second air suction passage 71 and fed into the housing unit 51. Therefore, since the air higher in flow rate than in the case illustrated in FIG. 17 flows through the housing unit 51, the drive board 50 is appropriately cooled.

Note that in the above example, the two switching mechanisms 80, 85 are opened and closed in three combinations, but may be opened and closed in four combinations. As combinations of opening just one of the two switching mechanisms 80, 85, both a configuration of opening only the first switching mechanism 80 illustrated in FIG. 17 and a configuration of opening only the second switching mechanism 85 may be adopted. For example, when the exhaust flow rates of the first fan 63 and the third fan 92 are different from each other, the flow rate of the air flowing through the housing unit 51 can be made different depending on which of the two switching mechanisms 80, 85 is opened. In such a case, the flow rate of the air flowing in the housing unit 51 may be adjusted in four levels by opening and closing the two switching mechanisms 80, 85 in the four combinations.

On the other hand, when an abnormality in the second fan 72 is detected, the controller 100 switches the two switching mechanisms 80, 85 from the closed state to the open state as shown in FIG. 19. That is, the controller 100 disposes both the on-off plates 81, 86 of the two switching mechanisms 80, 85 at the open position. The air discharged from the first fan 63 flows from the first bypass passage 68 into the second air suction passage 71. Further, the air discharged from the third fan 92 flows into the second air suction passage 71 from the first bypass passage 98. Therefore, the air exhausted from the two fans 63, 92 flows through the housing unit 51. Therefore, even when an abnormality occurs in the second fan 72, the drive board 50 can be appropriately cooled by sufficient air flowing through the housing unit 51. Therefore, even when an abnormality occurs in the second fan 72, the liquid ejection operation of the liquid ejection unit 40 can be performed. Therefore, the occurrence of downtime is prevented.

Further, when at least one of the two switching mechanisms 80, 85 is in the open state, the controller 100 may control the operating speed of the fan at the side corresponding to that switching mechanism set in the open state. That is, when at least one parameter out of the detected temperature, the duty value, the printing speed, and the size of the medium exceeds the corresponding threshold, the controller 100 may increase the operating speed of at least one of the fans 63, 92 from the first speed to the second speed. Note that by setting three or more thresholds, the controller 100 may control the operating speed of the fan 63, 92 in three or more combinations. Further, the controller 100 may control the second fan 72 at a plurality of levels of operating speeds based on the parameters described above.

### Advantages of Third Embodiment

According to the third embodiment, the advantages (1-1) to (1-7) of the first embodiment and the advantage (2-1) of the second embodiment are similarly obtained, and in addition, the following advantages are obtained.

(3-1) A plurality of sets (e.g., two sets) of the first air suction passage 61, 91, the fan 63, 92, the bypass passage 67, 97, and the switching mechanism 80, 85 are provided. The two switching mechanisms 80, 85 out of the plurality of sets switch between the open state and the closed state in four or three combinations. Therefore, it is easy to further reduce the size of the second fan 72 dedicated to cooling the drive board.

### Modified Examples

The present embodiment can be implemented with the modifications described below. The present embodiment and the following modified examples can be implemented in combination with each other as long as no technical inconsistencies are involved.

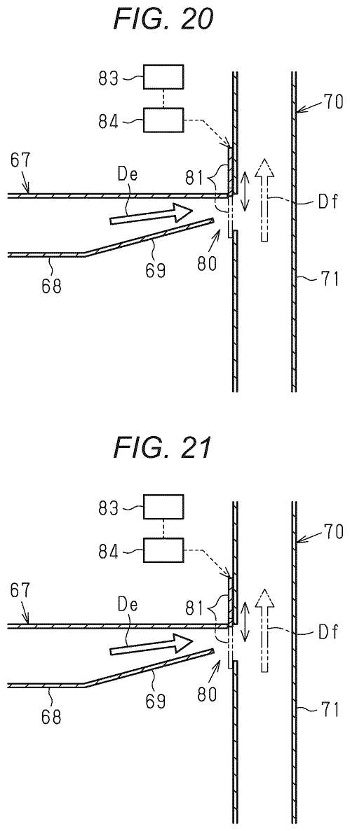

As shown in FIG. 20, the switching mechanism 80 of the rotary type may have a configuration in which the rotating shaft 82 is disposed at a downstream end portion of the first bypass passage 68.

As illustrated in FIG. 21, the switching mechanism 80 of the slide type may have a configuration in which the on-off plate 81 moves in the vertical direction. Further, the bypass passage 67 may be configured only with the first bypass passage 68. A configuration in which the second air suction passage 71 is provided only with an opening which is opened and closed by the on-off plate 81 and is located at a position opposed to the downstream end of the first bypass passage 68 may be adopted.

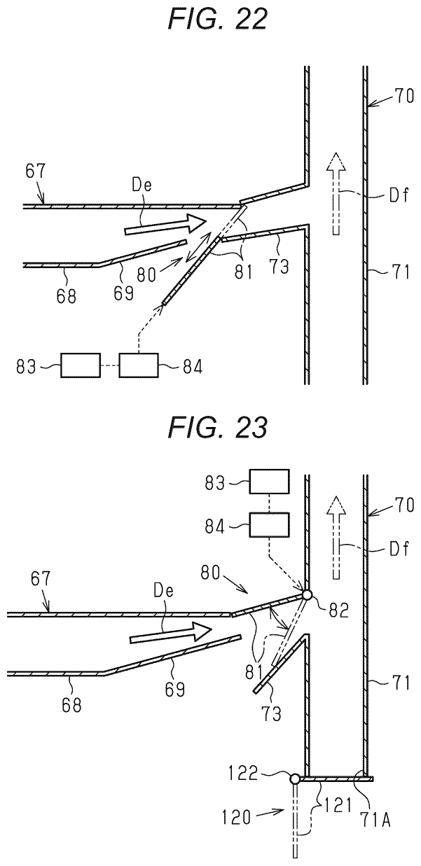

As illustrated in FIG. 22, unlike the on-off plate 81 illustrated in FIG. 6, the switching mechanism 80 of the slide type may be configured to be opened by the on-off plate 81 moving downward. Further, the direction in which the on-off plate 81 sliding is inclined with respect to a horizontal plane may be opposite to the direction in FIG. 6.

As shown in FIG. 23, when the switching mechanism 80 is referred to as the first switching mechanism 80, a third switching mechanism 120 that opens and closes the suction port 71A of the second air suction passage 71 may be provided in addition to the first switching mechanism 80. The third switching mechanism 120 includes an on-off plate 121 disposed so as to be rotatable about a rotating shaft 122. When the on-off plate 81 of the first switching mechanism 80 is located at the closed position, the on-off plate 121 of the third switching mechanism 120 is located at the open position indicated by the dashed-two dotted line in FIG. 23. Further, when the on-off plate 81 of the first switching mechanism 80 is located at the open position, the on-off plate 121 of the third switching mechanism 120 is located at the closed position indicated by the solid line in FIG. 23. According to this configuration, when the switching mechanism 80 is in the closed state, the second air suction passage 71 can suction air from the second suction port 71A. In addition, when the switching mechanism 80 is in the open state, the air flowing from the first bypass passage 68 into the second air suction passage 71 is less likely to leak from the second suction port 71A. Therefore, the air from the first bypass passage 68 can be efficiently used for cooling the drive board 50.

The position of the switching mechanism 80 may be a position near the first fan 63 instead of a position near the first air suction passage 61 in the bypass passage 67.

When the switching mechanism is the rotary type, the rotating shaft is not limited to a shaft parallel to the X axis, and may be a shaft parallel to the Y axis or a shaft parallel to the Z axis. Further, when the switching mechanism is the slide type, the sliding direction is not limited to a direction parallel to the Y-Z plane, and may be a direction parallel to the X-Y plane or a direction parallel to the X-Z plane.

The switching mechanism 80 may be of a type other than the rotary type and the slide type. For example, the rotary type and the slide type may be combined. Further, a plurality of on-off plates 81 may be combined. In this case, a plurality of on-off plates 81 of the same type may be combined, or a plurality of on-off plates 81 of different types may be combined. Further, it is possible to adopt a configuration in which when the switching mechanism is in the open state, the bypass passage 67 communicates only with the second air suction passage 71 without communicating with the outside.

The electronic circuit mounting board cooled by the second fan 72 may be another electronic circuit mounting board than the drive board 50 that outputs the drive signal to the liquid ejection unit 40. For example, an electronic circuit mounting board constituting the controller 100 may be the electronic circuit mounting board cooled by the second fan 72. Further, an electronic mounting board in which the electronic circuit constituting the controller 100 and the ejection controller 52 is mounted on the same circuit board such as a motherboard may be the electronic circuit mounting board cooled by the second fan 72. Further, the electronic circuit mounting board may be a power supply board.

In the third embodiment, when there are three combinations of opening and closing of the two switching mechanisms 80, 85, the second switching mechanism 85 may be set to the open state when either one of the two switching mechanisms 80, 85 is set to the open state.

In the third embodiment, control for switching the switching mechanisms 80, 85 with a single parameter may be performed. For example, two or three thresholds are set, and the number or combination of the switching mechanisms 80, 85 to be opened is changed every time the parameter value exceeds the threshold. The parameter may be one of the detected temperature, the duty value, the printing speed, and the size of the medium.

In the first and second embodiments, the switching mechanism may be controlled based on a plurality of parameters. The controller 100 may switch the switching mechanism from the closed state to the open state when at least one of the plurality of parameters exceeds the corresponding threshold. Two or more of the detected temperature, the duty value, the printing speed, and the size of the medium may be used as the parameters.

In the second and third embodiments, the destaticizing brush of the removal unit 35 is not required to be movable. In this case, the cleaning unit may be omitted. The foreign matter collection device 90 may be configured to have a third suction port 94A having a length over the entire width of the medium 16.

The switching mechanisms 80, 85 may be flow path switching valves. The flow path switching valve is coupled to, for example, a downstream end of the first bypass passage 68, and switches a discharge destination of the air between an exhaust flow path into the apparatus main body 12 and an inflow flow path communicating with the second air suction passage 71. The flow path switching valve can switch the discharge destination of the air while suppressing leakage of the air. Further, the flow path switching valve may have a flow rate adjustment function capable of adjusting the flow rate ratio for each flow path. In this case, the controller 100 may switch the switching mechanism and adjust an amount of the inflow air based on a comparison result between the parameter value and the threshold based on the parameter.

The paths and extending directions of the first air suction passage 61, 91 and the second air suction passage 71 may be changed as appropriate.

The liquid ejection apparatus 11 may be a printing apparatus that ejects a liquid onto fabric, which is an example of the medium 16. In this case, the foreign matter collection device 90 may be a device that collects fluff from the fabric.

In each of the embodiments described above, the devices having the first air suction passage and the first suction source are the mist collection device 60 and the foreign matter collection device 90, but may be other collection devices or other air suction devices. For example, a collection device that collects a collection target other than mist or paper dust or an air suction device that suctions air to form an airflow may be the device having the first air suction passage and the first suction source.

The liquid ejection apparatus 11 may be a serial printer. For example, the first air suction passage 61, 91 may be configured to suction air at at least one of positions upstream and downstream of the liquid ejection unit 40 in the relative movement direction between the medium 16 supported by the support unit 45 and the liquid ejection unit 40, and to cause the air to flow downstream in the suction directions Dm, Ds. In a case of the serial printer, the relative movement direction may be the conveyance direction D, or may be a movement direction (scanning direction) of a carriage including the liquid ejection unit 40. For example, the first air suction passage 61, 91 may suction the air at at least one of upstream and downstream positions in the conveyance direction D across the scanning path of the liquid ejection unit 40. Alternatively, for example, the first air suction passage 61, 91 may suction the air at at least one of the upstream position and the downstream position in the scanning direction which is a relative movement direction between the liquid ejection unit 40 moving in the scanning direction and the medium 16. In this case, at least one of the suction nozzle portions 66, 94 may be fixed to the carriage.

The drive board 50 may be incorporated in the liquid ejection unit 40. In this case, the second air suction passage 71 may be coupled to the liquid ejection unit 40 so that the air can be fed into the liquid ejection unit 40. In this case, a chassis of the liquid ejection unit 40 may be assumed as the housing unit, and the second fan 72, which is an example of the second suction source, may be fixed to the liquid ejection unit 40 so as to be able to suction the air in the chassis. In addition, the second air suction passage 71, through which the air flows along an outer surface of a portion which incorporates the drive board 50 of the liquid ejection unit 40, or a cooling fin provided on the outer surface, may be fixed to the liquid ejection unit 40. In this case, the second air suction passage 71 also serves as a flow path through which the air for cooling the surface to be cooled or the fins flows, and the second fan 72 is coupled to the downstream end portion of the second air suction passage 71. In addition, it is possible to adopt a configuration in which the housing unit 51 that accommodates the drive board 50 is disposed in the liquid ejection unit 40, and the air is fed from the second air suction passage 71 into the housing unit. Further, in these configurations, it is possible to adopt a configuration in which at least one of the two sets of the first air suction passage 61, 91 and the first fan 63, 92 as an example of the first suction source is provided, and at least one of the two sets of the bypass passage 67, 97 and the switching mechanism 80, 85 is provided.

The suction port of the first air suction passage 61, 91 is not required to face to the liquid ejection unit 40. For example, the third suction port 94A may face upstream instead of downstream in the conveyance direction D as long as the foreign matter such as paper dust can be suctioned. In short, the suction port 62A, 94A of the first air suction passage 61, 91 is not limited to the position and the direction in which the air located between the liquid ejection unit 40 and the support unit 45 can be suctioned. The direction of the suction port may be appropriately set as long as the air can be suctioned at at least one of the upstream and downstream positions of the liquid ejection unit 40 in the relative movement direction of the liquid ejection unit 40 and the medium 16.

The support unit 45 may be a table that supports the medium 16 conveyed. The support unit 45 may be, for example, a platen.

The liquid ejection apparatus 11 may be a liquid ejection apparatus that ejects a liquid other than ink. The state of the liquid to be ejected from the liquid ejection apparatus as a minute amount of droplet includes a particle state, a teardrop state, and a state of tailing like a thread. The liquid mentioned here is only required to be a material which can be ejected from the liquid ejection apparatus. For example, the liquid is only required to be a substance in a state in which the substance is in the liquid phase, and includes a liquid material high or low in viscosity, sol, gel water, other inorganic solvents, organic solvents, solutions, and a fluid material such as liquid resin, liquid metal, and metal melt. The liquid includes not only the liquid as a state of a substance, but also a liquid in which particles of a functional material made of a solid such as a pigment or a metal particle are dissolved, dispersed, or mixed in a solvent. Representative examples of the liquid include the ink and the liquid crystal as described in the above embodiments. Here, the term ink includes various types of liquid compositions such as general water-based ink, oil-based ink, gel ink, and hot melt ink. As a specific example of the liquid ejection apparatus, there is an apparatus that ejects a liquid containing a material such as an electrode material or a coloring material used in, for example, manufacture of a liquid crystal display, an electroluminescence display, a surface-emitting display, and a color filter in a dispersed or dissolved form. The liquid ejection apparatus may be an apparatus that ejects a bioorganic substance used for manufacturing a biochip, an apparatus that is used as a precision pipette and ejects a liquid to be a sample, a textile printing apparatus, a micro dispenser, or the like. The liquid ejection apparatus may be an apparatus that ejects lubricating oil to a precision machine such as a timepiece or a camera in a pinpoint manner, or an apparatus that ejects a liquid of transparent resin such as ultraviolet curing resin onto a substrate in order to form a minute hemispherical lens used for an optical communication element or the like, an optical lens, or the like. The liquid ejection apparatus may be an apparatus that ejects an etching liquid such as acid or alkali in order to etch a substrate or the like.

### Definition

The expression “at least one” used in this specification means “one or more” of desired alternatives. For example, the expression “at least one” used in the present specification means “either one of alternatives” or “both of two alternatives” when the number of the alternatives is two. As another example, the expression “at least one” used in the present specification means “just one alternative”, “a combination of any two alternatives”, or “a combination of any three or more alternatives” when the number of alternatives is three or more.

### Appendices

Technical ideas understood from the embodiments and the modified examples described above and the functions and advantages thereof will hereinafter be described.

(A) A liquid ejection apparatus includes: a liquid ejection unit configured to eject a liquid onto a medium; a support unit configured to support the medium at a position opposed to the liquid ejection unit; an electronic circuit mounting board; a first air suction passage configured to suction air at at least one of an upstream position and a downstream position of the liquid ejection unit in a relative movement direction between the medium supported by the support unit and the liquid ejection unit to cause the air to flow downstream in a suction direction; a first suction source configured to generate suction force capable of suctioning the air into the first air suction passage; a second air suction passage configured to feed external air to the electronic circuit mounting board; a second suction source configured to generate, in the second air suction passage, a flow of air in a feeding direction toward the electronic circuit mounting board; a bypass passage configured to feed, to the second air suction passage, the air discharged from the first suction source; and a switching mechanism configured to switch between an open state in which the bypass passage communicates with the second air suction passage and a closed state in which the bypass passage does not communicate with the second air suction passage.

According to the configuration described above, by switching the switching mechanism from the closed state to the open state, the air discharged by the first suction source can be used to cool the electronic circuit mounting board. Therefore, it is possible to suppress the occurrence of downtime when the second suction source is abnormal, or to suppress an increase in size due to an increase in the capacity of the second suction source. Therefore, even when the flow rate of the cooling air is insufficient due to the abnormality of the suction source dedicated to cooling the board or the limit of the capability, the electronic circuit mounting board can appropriately be cooled.

(B) The liquid ejection apparatus according to (A) described above, wherein when the liquid ejection unit performs the liquid ejection operation in a state where an abnormality occurs in the second suction source, the second suction source may be stopped, and the switching mechanism may be set to the open state.

According to the configuration described above, it is possible to suppress the occurrence of downtime in which the liquid ejection operation cannot be performed due to the abnormality of the second suction source.

(C) The liquid ejection apparatus according to (A) or (B) described above may further include: a housing unit configured to house the electronic circuit mounting board; and a detector configured to detect a temperature in the housing unit, wherein the switching mechanism may be set to the open state when the temperature detected by the detector exceeds a temperature threshold. According to the configuration described above, it is possible to shorten the time required to lower the temperature in the housing unit to the target temperature using the air fed by the first suction source.

(D) The liquid ejection apparatus according to any one of (A) to (C) described above, wherein the first suction source may be a mist collecting fan configured to generate suction force for collecting mist generated when the liquid ejection unit ejects the liquid.

According to the configuration described above, the mist generated when the liquid ejection unit ejects the liquid can be collected, and further, the air discharged by the mist collecting fan can be used to cool the electronic circuit mounting board. Therefore, it is possible to reduce the size of the second suction source and perform the liquid ejection operation when the second suction source fails.

(E) The liquid ejection apparatus according to any one of (A) to (D) described above may further include: a removal unit that removes foreign matter from the medium, wherein the first suction source may be a foreign matter collecting fan configured to collect the foreign matter from the removal unit.

According to the configuration described above, the foreign matter (e.g., medium powder) can be collected from the medium, and further, the air discharged by the foreign matter collecting fan can be used for cooling the electronic circuit mounting board. Therefore, it is possible to reduce the size of the second suction source and perform the liquid ejection operation when the second suction source fails.

(F) The liquid ejection apparatus according to any one of (C) to (E) described above, wherein when the switching mechanism is in the open state, the first suction source may be driven at a higher operating speed when the temperature detected by the detector is a second temperature higher than a first temperature than when the temperature detected by the detector is the first temperature.

According to the configuration described above, when the switching mechanism is in the open state, the first suction source is driven at an operating speed corresponding to the detected temperature in the housing unit, and thus it is possible to feed the air at a flow rate appropriate for cooling to the electronic circuit mounting board.

(G) The liquid ejection apparatus according to any one of (A) to (F) described above may include: a plurality of sets of the first air suction passage, the first suction source, the bypass passage, and the switching mechanism may be provided, wherein two of the plurality of switching mechanisms may switch the open state and the closed state in four or three combinations. According to the configuration described above, it is easy to further reduce the size of the second suction source for cooling the electronic circuit mounting board.

(H) The liquid ejection apparatus according to any one of (A) to (G) described above, wherein a portion of the bypass passage that reaches the switching mechanism in a discharge direction of the air may be formed in a tapered shape in which a passage cross-sectional area is smaller in a downstream portion than in an upstream portion. According to the configuration described above, when the switching mechanism is located at an open position, a decrease in the flow rate of the air flowing from the bypass passage into the second air suction passage can be suppressed.

(I) The liquid ejection apparatus according to any one of (A) to (H) described above, wherein the switching mechanism may include an on-off plate, and the on-off plate may be of a rotary type or a slide type.

According to the configuration described above, switching between merging and non-merging of the air is easy with a simple configuration by rotation or sliding of the on-off plate.

What is claimed is:

1. A liquid ejection apparatus comprising:
a liquid ejection unit configured to eject a liquid onto a medium;
a support unit configured to support the medium at a position opposed to the liquid ejection unit;
an electronic circuit mounting board;
a first air suction passage configured to suction air at at least one of an upstream position and a downstream position of the liquid ejection unit in a relative movement direction between the medium supported by the support unit and the liquid ejection unit to cause the air to flow downstream in a suction direction;
a first suction source configured to generate suction force capable of suctioning the air into the first air suction passage;
a second air suction passage configured to feed external air to the electronic circuit mounting board;
a second suction source configured to generate, in the second air suction passage, a flow of air in a feeding direction toward the electronic circuit mounting board;
a bypass passage configured to feed, to the second air suction passage, the air discharged from the first suction source; and
a switching mechanism configured to switch between an open state in which the bypass passage communicates with the second air suction passage and a closed state in which the bypass passage does not communicate with the second air suction passage.

2. The liquid ejection apparatus according to claim 1, wherein,
when the liquid ejection unit performs the liquid ejection operation in a state where an abnormality occurs in the second suction source,
the second suction source is stopped, and
the switching mechanism is set to the open state.

3. The liquid ejection apparatus according to claim 1, further comprising:
a housing unit configured to house the electronic circuit mounting board; and
a detector configured to detect a temperature in the housing unit, wherein
the switching mechanism is set to the open state when the temperature detected by the detector exceeds a temperature threshold.

4. The liquid ejection apparatus according to claim 1, wherein
the first suction source is a mist collecting fan configured to generate suction force for collecting mist generated when the liquid ejection unit ejects the liquid.

5. The liquid ejection apparatus according to claim 1, further comprising:
a removal unit that removes foreign matter from the medium, wherein
the first suction source is a foreign matter collecting fan configured to collect the foreign matter from the removal unit.

6. The liquid ejection apparatus according to claim 3, wherein
when the switching mechanism is in the open state, the first suction source is driven at a higher operating speed when the temperature detected by the detector is a second temperature higher than a first temperature than when the temperature detected by the detector is the first temperature.

7. The liquid ejection apparatus according to claim 3, further comprising:
a plurality of sets of the first air suction passage, the first suction source, the bypass passage, and the switching mechanism is provided, wherein
two of the plurality of switching mechanisms switch the open state and the closed state in four or three combinations.

8. The liquid ejection apparatus according to claim 1, wherein
a portion of the bypass passage that reaches the switching mechanism in a discharge direction of the air is formed in a tapered shape in which a passage cross-sectional area is smaller in a downstream portion than in an upstream portion.

9. The liquid ejection apparatus according to claim 1, wherein
the switching mechanism includes an on-off plate, and
the on-off plate is of a rotary type or a slide type.
